(19) United States
(12) Patent Application Publication
(10) Pub. No.: US 2023/0298358 A1
(43) Pub. Date: Sep. 21, 2023

(54) OBJECT DETECTION AND IDENTIFICATION SYSTEM AND METHOD FOR MANNED AND UNMANNED VEHICLES

(71) Applicant: BRIGHTWAY VISION LTD, Tirat Hacarmel (IL)

(72) Inventors: Eyal Yaakob LEVI, Tirat Hacarmel (IL); Ofer Bruce DAVID, Tirat Hacarmel (IL)

(21) Appl. No.: 18/036,011

(22) PCT Filed: Nov. 9, 2021
(86) PCT No.: PCT/IB2021/060364

§ 371 Date: May 9, 2023

(30) Foreign Application Priority Data
Nov. 10, 2020 (IL) 278629

(51) Int. Cl. G06V 20/58; H04N 23/56; G06T 7/586; G06T 7/507; G06V 10/25

(52) U.S. Cl. CPC G06V 20/58; H04N 23/56; G06T 7/586; G06T 7/507; G06V 10/25; G06T 2207/10028; G06T 2207/30261

(57) ABSTRACT

Embodiments pertain to a system that can be employed or that is included in a platform for detecting an obstacle to the platform in a scene. The system comprises, in an embodiment, a plurality of illuminators arranged at different locations of the platform; at least one imager; a processor; and a memory configured to store data and software code. The software code is executable by the processor to perform the following: illuminating the scene from at least two different directions by the plurality of illuminators; acquiring, by the at least one imager, a plurality of images of the illuminated scene; comparing at least one image of the scene illuminated from a first direction with at least one image of the scene illuminated from a second direction which is different from the first direction; and determining, based on the comparing, at least one shadow-related characteristic of the scene.

### CLAIM OF PRIORITY

This applications claims priority of Israel Patent application 278629, filed 10 Nov. 2020, titled “OBJECT DETECTION AND IDENTIFICATION SYSTEM AND METHOD FOR MANNED AND UNMANNED VEHICLES”, which is incorporated herein by reference in its entirety.

### TECHNICAL FIELD

The present disclosure relates in general to apparatuses, systems and devices employable by stationary or movable platforms for automated obstacle detection under good visibility and low-visibility conditions.

### BACKGROUND

Imaging systems that are aimed at improving visibility have been employed in civilian applications for many years. Such imaging systems produce images that improve visibility to allow navigate and steer a vehicle under good visibility and weather conditions, as well as under poor visibility and adverse weather conditions such as during night, rain, fog and/or dust.

In general, images can be obtained actively and passively. Passive imaging systems may use infrared electromagnetic (EM) radiation emanating from the objects to enhance their visibility. A passive imaging systems may for example utilize a thermal sensor that generates “emitted-based” image data to produce an image according to intensity differences of the infrared radiation. Additionally or alternatively, passive imaging systems may use sources of ambient EM radiation (also: ambient light) that may reflect from and/or scatter off objects that are present in an environment being imaged. Such sources of ambient EM radiation can for example include traffic lights, streetlights, vehicle low/high beams, moonlight and/or starlight.

Active imaging systems may rely, on the other hand, on an artificial light source that is part of the system and employed for illuminating a scene. Responsive to illuminating a scene, light may be reflected from objects located within that scene and detected by a light sensor of the active imaging system to produce “reflection-based” image data.

In case characteristics of pertaining to light emanating from an object such as, for example, reflectance and/or emissivity of an object and its surroundings are (e.g., substantially) identical such that the object being imaged blends into its surroundings, the identification of an object as an obstacle may pose challenges to both active and passive imaging techniques.

The description above is presented as a general overview of related art in this field and should not be construed as an admission that any of the information it contains constitutes prior art against the present patent application.

### BRIEF DESCRIPTION OF THE FIGURES

The figures illustrate generally, by way of example, but not by way of limitation, various embodiments discussed in the present document.

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. References to previously presented elements are implied without necessarily further citing the drawing or description in which they appear. The figures are listed below.

FIG. 1 is a schematic block diagram illustration of an object detection and identification (ODI) system, according to some embodiments.

FIGS. 2A-10B show various image acquisition scenarios, according to some embodiments.

FIG. 11 is a diagram for determining a distance between an object protruding above ground and an imager of the system, according to some embodiments.

FIG. 12 schematically shows the gated imaging of a scene with different depths-of-fields, according to some embodiments.

FIGS. 13A and 13B are schematic top view illustration of performing gated imaging of an object, according to some embodiments.

FIG. 14 is a schematic functional block diagram illustration of the components of a pixel element, according to some embodiments.

FIG. 15 is a schematic block diagram illustration of the architecture of an image sensor, according to some embodiments.

FIG. 16 is a flowchart of a method for performing object characterization, according to some embodiments.

### DETAILED DESCRIPTION

The following description discloses non-limiting examples of systems and methods for determining one or more object-related characteristics of at least one object in a scene. Such object-related characteristic may pertain to or include shadow-related characteristic, for example, to perform shadow-based object detection and identification (ODI). Shadow-based object detection and identification may be based on performing active scene illumination to generate, detect and/or change the appearance of shadows cast by objects in the scene.

A stationary or movable platform may comprise an ODI system, which is configured to interrogate a viewable scene in which the platform is located to generate image data descriptive of the interrogated scene. The ODI system is in some embodiments further operable to detect, based on the generated image data, the presence of an object which features or exhibits, under certain scene interrogation conditions, light-emanating properties (e.g., reflected from) that are identical or similar to the object's background. In other words, the ODI system is in some embodiments operable to detect objects that blend into their surroundings or background. The term “emanating light” as well as grammatical variations thereof may refer to light that passively radiates from the object and/or to light that is reflected from the same object.

The term “identical light characteristics” as used herein may also encompass the term “substantially identical light characteristics”. Example scenarios in which an object can have, for example, a reflectance that is (e.g., substantially) identical to the object's background can include non-reflective object blending with a shadow cast by the same or another object, camouflage fabric, black rubber tire overlying an oil spill, and/or the like.

In some embodiments, the ODI system is operable to distinguish, based on the generated image data, between a non-reflective (and optionally non-solid) object that is substantially flush with and/or overlaying the driving surface in manner not posing an obstacle to a driving or moving platform, and a non-reflective, optionally solid object that protrudes above the (e.g., platform's traversing or driving) surface being imaged and which therefore may pose an obstacle to such platform.

The term “non-reflective” as used herein may also encompass the term “substantially non-reflective”. Example non-reflective objects include black synthetic material (e.g., rubber), tire tread, motor oil, objects painted with black paint or coated with anti-reflection coatings, non-reflective metals, and/or the like.

In some embodiments, the ODI system may be operable to detect and/or identify foreground objects that may blend into their background scene. This may be accomplished by actively illuminating a region of interest (ROI) of a scene with an illuminator to increase contrast of objects against their background. Illuminating the ROI causes a detectable shadow being cast by such objects. If no such object is present, illuminating the ROI does not cause casting of such detectable shadow.

In one example scenario, a white object may blend into its white background (e.g., white ski suit against a background with snow), and illuminating the white object may increase its contrast against the white background.

The ODI system is therefore operable to detect the presence of an obstacle along a platform's traversing (e.g., driving) route or in scenarios where the obstacle is non-reflective and/or blends into the object's background.

It is noted that the ODI system may in some embodiments be supplemental to a platform. In other words, a vehicle may be retrofitted with the ODI system. In some embodiments, ODI system may be pre-installed in the platform.

The term “platform” may include, for example, any kind of moving platforms including, for instance, two-wheeled vehicles, any kind of three-wheeled vehicles, four-wheeled vehicles, land-based vehicles including, for instance, a passenger car, a motorcycle, a bicycle, a transport vehicle (e.g., a bus, truck, a rail-based transport vehicle such as a train, subway or any other mass transport system, etc.), a watercraft; a robot, a pedestrian wearing gear that incorporates, for example, an (e.g., gated) imaging system; a submarine; a multipurpose vehicle such as a hovercraft and/or the like. Optionally, a vehicle may be a fully autonomous vehicle (for example a self-driving car) and/or a partially autonomous vehicle, a manned movable platform an unmanned movable platform. In some embodiments, the vehicle may be a manned or unmanned aerial vehicle (UAV). For example, the system may be used by a manned or unmanned aerial vehicle to facilitate navigation of the airborne vehicle between buildings in a dense urban environment. The system may for example differentiate between black surfaces on building walls and objects that are positioned at some distance away from building walls.

The platform may also pertain to stationary platforms such as watchtowers.

Additional applications of the platform may include outdoor (e.g., perimeter) surveillance applications and/or indoor surveillance applications such as, for example, mass transportation security (e.g., airports, seaports, railway stations, etc.); critical infrastructure surveillance (e.g., energy plants, oil and gas pipelines, water reservoirs, etc.); urban infrastructure monitoring applications (e.g., traffic monitoring); airspace surveillance including, for example, detection and identification of airborne vehicles (e.g., drones), and/or the like.

The ODI system comprises one or more illuminators, one or more imagers, one or more controllers and a scene analyzer engine. It is noted that terms “imager”, “detector”, “light sensor” and “image sensor” may herein be used interchangeably. Such light sensor may be configured to detect light of the visible spectrum and/or the non-visible spectrum including, for example, IR light.

Methods and systems may be optionally configured to provide images of the scene, to operate in daytime and/or in nighttime, to operate in inclement weather (rain, snow, smog, dust, etc.) and/or to operate from static and from moving platforms.

At least one illuminator and at least one imager of the ODI system are spaced apart at sufficient distance (parallax) from each other to enable the imaging of a shadow cast by an object protruding above a surface for characterizing (classifying) the object as an obstacle or non-obstacle.

The at least one illuminator and at least one imager of the ODI system may be operated to actively illuminate and image a scene, regardless of the instant conditions, or only if a ROI has been identified. The actively illuminating and imaging of the scene may be performed in one of a non-gated imaging mode and a gated imaging mode.

Optionally, a platform employing an ODI system may herein also be referred to as a “ODI platform”. Merely, to simplify the discussion that follows, without to be construed in a limiting manner, an ODI system is in the accompanying figures illustrated as comprising elements such as illuminators.

An illuminator is operable to actively illuminate the scene with light from a plurality of different illumination positions relative to an object located in the scene, to generate scene-reflections which are acquired by the one or more imagers.

Optionally, a plurality of illuminators may be employed which are arranged at some distance from each other on or in the platform to allow illuminating the scene from different angles and/or positions. In some examples, the plurality of illuminators may be implemented by a single light source and optics (e.g., a system comprising actuatable lenses and/or mirrors) that are configured to controllably illuminate an object from different directions. Optionally, a same illuminator may be employed which is arranged at a given position of the platform for illuminating the scene from a plurality of different positions if the platform comprising the same illuminator traverses a distance of sufficient magnitude relative to the object allowing the detection of obstacles using a “shadow detection”-based (SDB) method, as outlined herein in more detail.

An imager comprises a plurality of pixel elements which are operable to acquire, at least, the scene reflections generated responsive to actively illuminating the scene by the illuminator. The imager is further operable to produce, based on the scene reflections, a plurality of reflection-based image data sets of the scene.

The controller is operably coupled with the illuminator to allow selective (also: controlled) activation of the illuminator. In some embodiments, the imager is operably coupled with controller to allow activation thereof. In some embodiments, the controller may selectively active and deactivate the illuminator and imager in timed coordination with each other to implement gated imaging techniques, for example, to perform shadow detection for one or more selected depth-of-fields (DOEs).

Gated imaging techniques may for example be implemented as specified in PCT/IL2016/050770 (“GATED STRUCTURED IMAGING”, filed 14 Jul. 2016), and/or as specified in PCT/IB2016/057853 (“GATED IMAGING APPARATUS, SYSTEM AND METHOD”, filed 21 Dec. 2016), both of which are incorporated herein by reference in their entirety.

The term “gated imaging” as used in this application refers to analyzing reflections of scene illumination according to the radiation's traveling time from the illuminator to the scene and back to the detector, and relating the analyzed reflections to the corresponding depth ranges in the scene from which they were reflected. In particular, the detector does not collect any information while the pulse of light is projected but only after the traveling time has passed. A single image readout from the detector (sensor) includes one or more single image sensor exposure(s), each corresponding to a different traveling time.

The terms “depth”, “depth range”, “depth-of-field” or slices as used in this application refer to distances between scene segments and illuminator(s) and/or imager(s). The terms “depth” or “depth range” may relate to a single distance, a range of distances and/or weighted distances or distance ranges in case illuminator(s) and Imager(s) are spatially separated.

The term “traveling time” as used in this application refers to the time it takes an illumination pulse to travel from an illumination source to a certain distance (depth, or depth range) and back to the detector (see more details below).

The terms “integration” and “accumulation” as used in this application, are corresponding terms that are used interchangeably and to the collection of the output signal over the duration of one or more time intervals.

The scene analyzer engine is operable to analyze the plurality of reflection-based image data sets (e.g., relating to one or selected depth-of-fields) to determine whether the scene comprises an obstacle. In some embodiments, the scene analyzer engine may be configured to implement artificial intelligence functionalities by employing one or more machine learning models such as artificial neural networks (ANNs). For example, machine learning models may be employed for classifying an object as an obstacle or non-obstacle.

In some embodiments, the scene analyzer engine is operable to distinguish between objects of a first type which protrude above a surface and objects of a second type that are overlaying the surface in a manner such that they do not pose an obstacle or collision risk to the platform comprising the ODI system or to another platform.

The ODI system may provide an output descriptive of the object (e.g., “obstacle” or “non-obstacle”) to a second platform that does not necessarily comprise an ODI system to indicate the second platform whether the object may or may not pose an obstacle to the second platform.

In some embodiments, the ODI system may consider the route about to be traversed by a platform to determine whether the object can constitute an obstacle to this platform or not. In one example, the ODI system may be part of the platform traversing the route. In another example, the ODI system may be part of another platform which is remotely located from the platform traversing the route.

Generally, the ODI system may be operable to implement the SDB method for identifying objects as obstacles. Such SDB method may comprise, for example, acquiring two scene images, for example by generating at least two sets of reflection-based image data descriptive of a scene that is interrogated to allow the characterization of objects in the scene based on shadow-based characterizations of an ROI in the scene. Characterizing an ROI includes determining whether the ROI includes an object that protrudes above the platform's support (e.g., driving or traversing) surface, or not. In one example, this may be accomplished by illuminating the ROI, sequentially, from two different directions while acquiring, for each different illumination direction, an image from a same ROI imaging direction. In a further example, this may be accomplished by illuminating the ROI from one direction and acquire at least two images from the different imaging directions while the ROI is being illuminated.

The method further includes analyzing at least two of the plurality of acquired scene images (e.g., images of a scene illuminated from two or more different directions and/or imaged from two or more different directions) to yield an analysis output.

The process of analyzing the plurality of images may include comparing the dataset of a first image of the plurality of images with a dataset of a second image of the plurality of images to yield the analysis output. The analysis output may for example contain information regarding the increase or emergence (or, conversely, information regarding the decrease or disappearance) of a non-reflective area, or regarding the disappearance or decrease of a non-reflective area in the scene. An emergence or increase of non-reflective area as well as the disappearance or decrease such non-reflective area in the scene may be indicative of the presence of an object in the scene which protrudes above the vehicle's driving surface.

In case the interrogation yields an output indicative of the detection of shadow, the corresponding area containing the shadow or object may be characterized (e.g., classified) as an “obstacle”. In case no shadow is detected, the object may be classified as a “non-obstacle”. Optionally, supervised and/or unsupervised machine learning techniques may be employed for object classification.

In the discussion that follows, without to be construed in a limiting manner, the plurality of reflection-based image datasets may be exemplified by “a first and a second reflection-based image dataset”. Clearly, the plurality of reflection-based image datasets can include more than two reflection-based image datasets.

Considering for instance a scenario in which first active scene imaging parameter values yield a first reflection-based image dataset descriptive of a scene that comprises an object which blends into the surroundings, and in which second active scene imaging parameter values yield a second reflection-based image dataset descriptive of the scene comprising the same object and, in addition, a non-reflective region (also: shadow area) not described by the first reflection-based image dataset. The shadow area thus emerged as a result of imaging the object using at least two different active scene imaging parameter values. Since the scene contains an object that casts a shadow, it protrudes above the driving surface, and the object (or the area in the vicinity of the cast shadow) may therefore be characterized as an obstacle.

If, on the contrary, the first and second active scene imaging parameter values do not yield first and second reflection-based image datasets descriptive of the emergence/disappearance of a shadow area, the object may be characterized as a “non-obstacle”.

Considering for instance another scenario in which first active scene imaging parameter values yield a first reflection-based image dataset descriptive of a scene that comprises a non-reflective object not blending into the surroundings and having a first contour geometry, and in which second active scene imaging parameter values yield a second reflection-based image dataset descriptive of the scene and the non-reflective object with second contour geometry, different from the first contour geometry. Again, the change in the object's contour geometry can be considered to be a result of imaging the object using at least two different scene imaging parameter values. From the change in the contour geometry, it can be derived that the object casts a shadow, therefore protruding above the driving surface. The object may therefore be characterized as an obstacle. A change in the contour geometry can include an increase or decrease in the non-reflective (shadow) area.

If, on the other hand, the first and second active scene imaging parameter values do not yield an output indicative of a change in the object's contour geometry, the object may be characterized as a non-obstacle.

A scene may be interrogated in a variety of manners as exemplified herein below. Various active scene imaging methods may be employed for generating reflection-based image datasets suitable for SBD methods for object detection and identification.

In some examples a shadow detection-based or SBD method may include illuminating the scene by an illuminator from a first illumination direction and acquiring, using a first image acquisition direction, reflections from the scene which are produced responsive to illuminating the scene from the first illumination direction to acquire a first image (e.g., generate a first reflection-based image dataset).

The SBD method may further include illuminating the scene by an illuminator from a second illumination direction and acquiring, using the first image acquisition direction, images while illuminating the scene from the second illumination direction to acquire a second image (e.g., generate a second reflection-based image dataset). The second illumination direction is different from the first illumination direction.

In some embodiments, the scene may be illuminated from the first and second illumination direction by the same illuminator, for example, from a driving platform changing the position of the illuminator between from the first to the second illumination direction.

In some embodiments, the scene may be illuminated from a plurality of different illumination directions relative to an object located in the scene by using a plurality of illuminators which are installed at different positions, e.g., of the vehicle and relative to the same imager, for allowing illuminating the same object from a plurality of directions.

In some embodiments, the scene may be simultaneously illuminated from different directions relative to an image acquisition direction, e.g., by employing a plurality of illuminators emitting, for example, light having different characteristics.

In some embodiments, the same illuminator may be employed from a plurality of different locations for illuminating the scene from a plurality of different directions. For example, the scene may be illuminated at different timestamps t1 and t2, t2>t1, by an illuminator included in a platform traversing the scene.

In a further example, the SBD method may include illuminating the scene by an illuminator from a first illumination direction and acquiring reflections from the scene from a plurality of different image acquisition directions to acquire a plurality of scene images (e.g., generate a plurality of reflection-based image datasets). According to the second example, a first and second scene image may thus be generated by employing a plurality of different active scene imaging parameter values (e.g., wavelengths, phases, polarization, etc.).

Optionally, scene reflections may be acquired at a plurality of different locations using a plurality of imagers which are installed at different positions in or on the platform. Optionally, scene reflections may be acquired simultaneously at different locations in the scene using a plurality of imagers employing, for example, different scene imaging parameter values. In some embodiments, scene imaging parameter values may pertain to different light characteristics employable by the one or more illuminators and/or to characteristics of the one or more imagers. Such light characteristics may include, for example, to the light's wavelength; amplitude; polarization; a phase difference; data encoded in the light; or any combination of the aforesaid.

In some embodiments, scene reflections may be acquired at a plurality of different locations using the same imager. For example, scene reflections may be acquired at different timestamps t1 and t2, t2>t1, by an imager included in a driving vehicle traversing the scene.

In some additional examples, the SBD method may include illuminating the scene from a plurality of different illumination directions, and acquiring reflections from the scene from a plurality of different image acquisition directions to generate a plurality of reflection-based image datasets that pertaining to a respective plurality of different scene imaging parameter values.

As already outlined herein, the SBD method may include, for example, analyzing the first and second reflection-based image dataset to yield an analysis output. The process of analyzing the first and second reflection-based image dataset may include comparing the plurality of reflection-based image datasets with each other to yield the analysis output, which may, for example, contain information regarding the emergence/disappearance of a shadow, and/or regarding change in the contour geometry of a non-reflective object in the scene. The analysis output may further include classification information regarding an imaged object. Such object may, for example, be classified as “obstacle” or “non-obstacle”. For example, if the scene analysis engine determines that an imaged object casts a shadow, it is characterized as “obstacle”, and if the scene analysis engine determines that an imaged object does not cast a shadow, it is characterized as a “non-obstacle”.

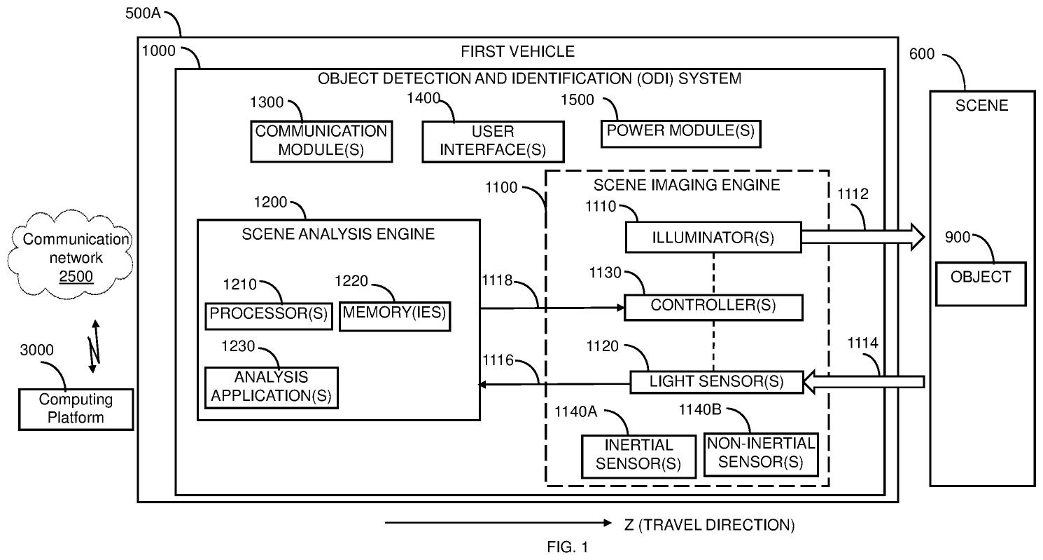

Referring now to FIG. 1, a first vehicle 500A may employ an object detection and identification (ODI) system 1000 operable to actively image a scene 600 comprising objects 900 for generating a plurality of reflection based image datasets and obstacle identification, e.g., by employing object characterization (e.g., classification). Optionally, ODI system may be operable selectively image a scene by controllably applying active scene imaging parameter values. Controllable application of active scene imaging parameter values may be performed in a dynamic and/or adaptive manner.

In some embodiments, ODI system 1000 may comprise a scene imaging engine 1100 for actively imaging scene 600 and generating a plurality of reflection-based image datasets; a scene analysis engine 1200 for determining if the imaged scene comprises an obstacle to a moving platform (e.g., first vehicle 500A); a communication module 1300; a user interface 1400; and a power module 1500 for powering the various components, applications and/or elements of ODI system 1000.

Components, modules and/or elements of ODI system may be operatively coupled with each other, e.g., may communicate with each other over one or more communication buses (not shown) and/or signal lines (not shown), for implementing methods, processes and/or operations, e.g., as outlined herein.

Scene imaging engine 1100 may include one or more illuminators 1110 that are operable to emit light 1112, schematically indicated herein to propagate in space in positive Z direction, one or more light sensors 1120 (e.g., a pixelated image sensor or imager) that are configured to detect 9reflected) light 1114 incident onto light sensor 1120; and a controller 1130 for controlling the operation of illuminator(s) 1110 and/or light sensor 1120.

Without derogating from the aforesaid and merely to simplify the discussion that follows herein, the above-referenced one or more elements having identical or similar functionality and/or structure may herein be referred to in the singular. For instance, “the one or more illuminators 1110” may herein sometimes simply be referred to as “illuminator 1110”.

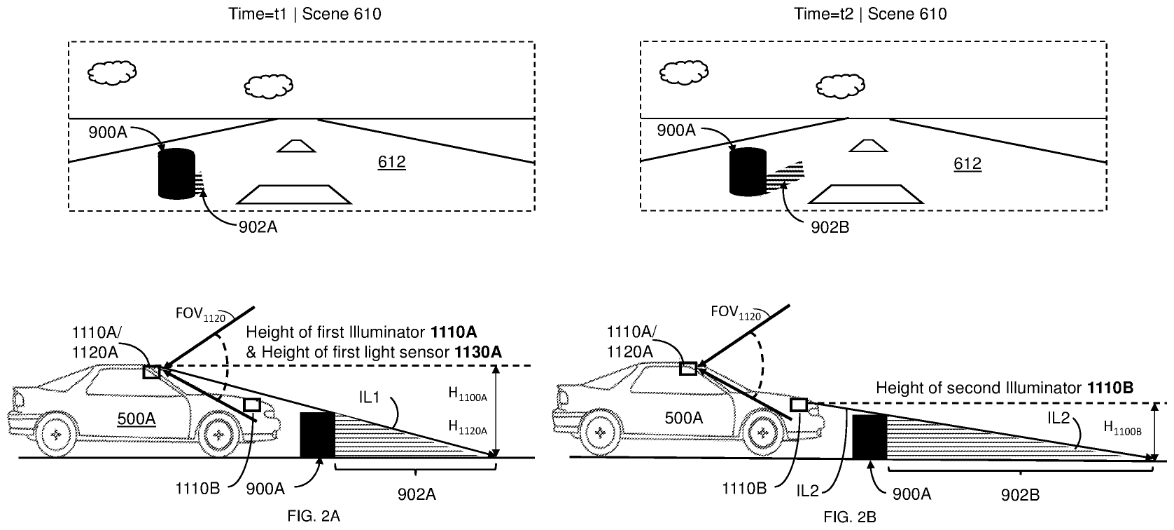

Light 1114 may include light reflected from scene 610 (FIG. 2) responsive to active scene illumination and, optionally, non-reflected (also: ambient) light emanating from scene 600. The term “ambient light” as used herein may refer to light emitted from natural and/or artificial light sources and to light which is free or substantially free of radiation components produced responsive to actively illuminating the scene by the light source(s) employed by ODI system 1000 and/or free of pixel values originating from other light sensor pixels elements. Natural light sources may for example comprise sunlight, starlight and/or moonlight. Artificial light sources may for example comprise city lights; road lighting (e.g., traffic lights, streetlights); light reflecting from and/or scatter off objects that are present in an environment being imaged; and/or platform light (e.g., vehicle headlights such as, for example, vehicle low and high beams). Optionally, artificial light sources may include light sources of ODI systems employed by other vehicles. Data descriptive of natural light sources may herein be referred to as “passive image data”.

Pixel values descriptive of light 1114 detected by light sensor 1120 may be converted into image data 1116 for further analysis by a scene analysis engine 1200 of ODI system 1000.

Optionally, illuminator 1110 may be operable to emit light of the infrared (IR) spectrum (or another non-visible spectrum) and/or the visible spectrum. The IR spectrum (also: IR light) may encompass the near-infrared (NIR), short-wavelength IR (SWIR). Optionally, illuminator 1110 may be operable to emit “broad-spectrum light”, which refers to electromagnetic radiation extending across a spectrum, and which can, for example, include wavelength components of the visible and the IR spectrum, without being centered about a predominant wavelength. Merely to simplify the discussion that follows, without be construed limiting in any way, broad-spectrum light may herein be referred to as “visible light”. In some examples, broad-spectrum light may have a spectral width 50 nm.

Illuminator 1110 may include high beam light source and low beam light sources. High beam light sources may include, for example, driving beams, (e.g., front fog lamps), and full beams. Low beam light sources may include, for example, front fog lamps, daytime and/or nighttime conspicuity light sources, front position lamps; reversing lamps, and front position lamps.

The platform lighting and/or its broad-spectrum light sources may employ a variety of lighting technologies including, for example, incandescent lamps (e.g., halogen), electrical gas-discharge lamps (e.g., high-intensity discharge lamps or HID); light emitting diodes (LED), phosphor-based light sources and/or the like.

Light sensors 1120 may be operable to detect light of the visible and/or the IR spectrum.

Some of the pixels of light sensor 1120 may only be responsive to IR light, and some pixels may be responsive to light in the visible spectrum which may, optionally, comprise a portion of the IR spectrum. It is noted that merely for the sake of clarity and/or to simplify the discussion herein, certain components may be illustrated as being physically separate from each other. For example, light sensor 1120 may embed controller 1130.

Illuminator 1110 and/or light sensor 1120 may be controllable by controller 1130 to illuminate scene 600 and/or acquire reflections from different illumination angles to characterize objects to detect obstacles to a platform. As already indicated herein, a method for object characterization (e.g., classification and/or the identification of obstacles) may be based on determining at least one shadow-related characteristic including, for example, shadow detection. Such method may comprise interrogating a scene by ODI system 1000 to acquire images (e.g., to generate reflection-based image data) of an actively illuminated scene and determine, based on the acquired images, whether the scene includes objects that protrude above a (e.g., driving) surface and which can therefore cast a shadow thereon and/or whether the imaged scene includes an object that blends into its surroundings.

The term “determining at least one shadow-related characteristics” and the expression “generating data descriptive of at least one shadow-related characteristics”, as well as corresponding grammatical variations thereof, may herein be used interchangeably.

Scene analysis engine 1200 may be operable to determine whether the scene includes objects overlaying and protruding the surface and which could therefore pose, for example, an obstacle to a vehicle traveling in the object's direction. In some embodiments, scene analysis engine 1200 may comprise a processor 1210 and a memory 1220 for the execution of at least some of the methods, processes and/or operations described herein. Processor 1210 may include one or more processors, and memory 1220 may include one or more memories. Memory 1220 may be configured to store data and executable software code (e.g., algorithm codes and/or machine learning models).

Processor 1210 may for instance execute instructions stored in memory 1220 resulting in scene analysis applications 1230 that analyze image data 1116.

Optionally, scene analysis engine 1200 may generate control data 1118 that is input to light controller 1130 for controlling the operation of illuminators 1110 and/or light sensor 1120. For example, control data 1118 may be input to controller 1130 for adaptively controlling operation illuminator 1110 and/or light sensor 1120, e.g., for repeatedly imaging the same object in a manner such to increase the probability of generating detectable shadow areas. For example, in case scene analysis engine 1200 cannot conclusively determine based on previously acquired images if the said object may pose an obstacle or not, control data 1118 may track and repeatedly image the same object to acquire additional scene images until scene analysis engine 1200 can conclusively determine whether the imaged object can pose an obstacle or not. The term “conclusively” as used herein may refer to an output indicative that an object poses an obstacle (or not) at a probability which is above a certain probability threshold. For example, a probability of at least 80%, at least 90% or of at least 95% that an object is an obstacle may be considered to be conclusive.

The term “processor”, as used herein, may also refer to a controller, and vice versa. Controller 1130 and processor 1210 may be implemented by various types of controller devices, processor devices and/or processor architectures including, for example, embedded processors, communication processors, graphics processing unit (GPU)-accelerated computing, soft-core processors and/or embedded processors.

Memory 1220 may include one or more types of computer-readable storage media including, for example, transactional memory and/or long-term storage memory facilities and may function as file storage, document storage, program storage, or as a working memory. The latter may for example be in the form of a static random access memory (SRAM), dynamic random access memory (DRAM), read-only memory (ROM), cache and/or flash memory. As working memory, memory 1220 may, for example, include, e.g., temporally-based and/or non-temporally based instructions. As long-term memory, memory 1220 may for example include a volatile or non-volatile computer storage medium, a hard disk drive, a solid state drive, a magnetic storage medium, a flash memory and/or other storage facility. A hardware memory facility may for example store a fixed information set (e.g., software code) including, but not limited to, a file, program, application, source code, object code, data, and/or the like.

As already indicated herein, ODI system 1000 may comprise communication module 1300, user interface 1400 and power module 1500.

Communication module 1300 may, for example, include I/O device drivers (not shown) and network interface drivers (not shown) for enabling the transmission and/or reception of data over a communication network 2500 for enabling, e.g., communication of components and/or modules of ODI system 1000 with components, elements and/or modules of vehicle 500A and/or for enabling external communication such as vehicle-to-vehicle (V2V), vehicle-to-infrastructure (V2I) or vehicle-to-everything (V2X). For example, components and/or modules of ODI system 1000 may communicate with a computing platform 3000 that is external to vehicle 500A via communication network 2500. A device driver may for example, interface with a keypad or to a Universal Serial Bus (USB) port. A network interface driver may for example execute protocols for the Internet, or an Intranet, Wide Area Network (WAN), Local Area Network (LAN) employing, e.g., Wireless Local Area Network (WLAN)), Metropolitan Area Network (MAN), Personal Area Network (PAN), extranet, 2G, 3G, 3.5G, 4G including for example Mobile WIMAX or Long Term Evolution (LTE) advanced, 5G, Bluetooth® (e.g., Bluetooth smart), ZigBee™, near-field communication (NFC) and/or any other current or future communication network, standard, and/or system.

User Interface 1400 may for example include a keyboard, a touchscreen, an auditory and/or visual display device including, for example, a head up display (HUD), an HMD and/or any other wearable display; an electronic visual display (e.g., an LCD display, an OLED display) and/or any other electronic display, a projector screen, and/or the like. User interface 1400 may output a potential warning message in response to identifying (e.g., classifying) an object as an obstacle. Conversely, user interface 1400 may provide a clearance message indicating that an object does not pose an obstacle to the driving vehicle.

User Interface 1400 may display fused image information based on additional data provided, for example, by other sensors which are imaging scene 600.

Power module 1500 may comprise an internal power supply (e.g., a rechargeable battery) and/or an interface for allowing connection to an external power supply.

ODI system 1000 may further include inertial sensors 1140A (e.g., e.g., one or more accelerometers and/or gyroscopes), and/or non-inertial sensors 1140B such as, for example, optical sensors, altimeters, additional light sensors, pressure sensors, contact sensors, etc.

Reference is now made to FIGS. 2A and 2B. According to some embodiments, ODI system 1000 may be operable to illuminate a first scene 610 from at least two different illumination directions and acquire reflections from at least one image acquisition direction. A first illumination direction is schematically illustrated in FIG. 2A by arrow ILL and a second illumination direction is schematically illustrated in FIG. 2B by arrow IL2. The orientation or image acquisition direction is schematically shown by FOV₁₁₂₀. In the example scenario shown in FIG. 2A, a first illuminator 1110A and a first light sensor 1120A are at the same height above ground (also: driving surface) 612, i.e., H_{1110A}=H_{1120A}. First object 900A is exemplified as being non-reflective to light emitted by first and second illuminators 1110A and 1110B.

In the scenario shown in FIG. 2A, illuminating first scene 610 using a first illumination direction causes first non-reflective object 900A to cast a first shadow area 902A, schematically illustrated by “horizontal” stripes. The first shadow area 902A may not be distinguishable from object 900A. Accordingly, first shadow area 902A may not be identifiable as such. Optionally, the first shadow area 902A may be displayed to a user (e.g., a driver of first vehicle 500A) as being a portion of object 900A. The scene shown schematically in FIG. 2A is imaged by light sensor 1120A to generate a first reflection-based image dataset.

In the scenario shown in FIG. 2B, illuminating first scene 610 using a second illumination direction IL2 causes first non-reflective object 900A to cast a second shadow area 902B. As in the scenario shown in FIG. 2A, first shadow area 902A may not be distinguishable from object 900A.

The scene shown schematically in FIG. 2B is imaged by light sensor 1120A to generate a second reflection-based image dataset. Second shadow area 902B acquired by first light sensor 1120A may be displayed to a user (e.g., a driver of first vehicle 500A) as being a portion of first object 900A.

The first and second acquired images while illuminating first scene 610 are descriptive of different shadow areas. Hence, first object 900A in combination with first shadow area 902A may exhibit a contour geometry which is different from the contour geometry of first object 900A in combination with second shadow area 902B. The two different contour geometries, which are described by the first and second reflection-based image datasets, provide an indication that first object 900A protrudes above ground of driving surface 612. Accordingly, an analysis of the first and second reflection-based image datasets by scene analysis engine 1200 may result in determining that first object 900A may pose an obstacle, e.g., to vehicle 500A.

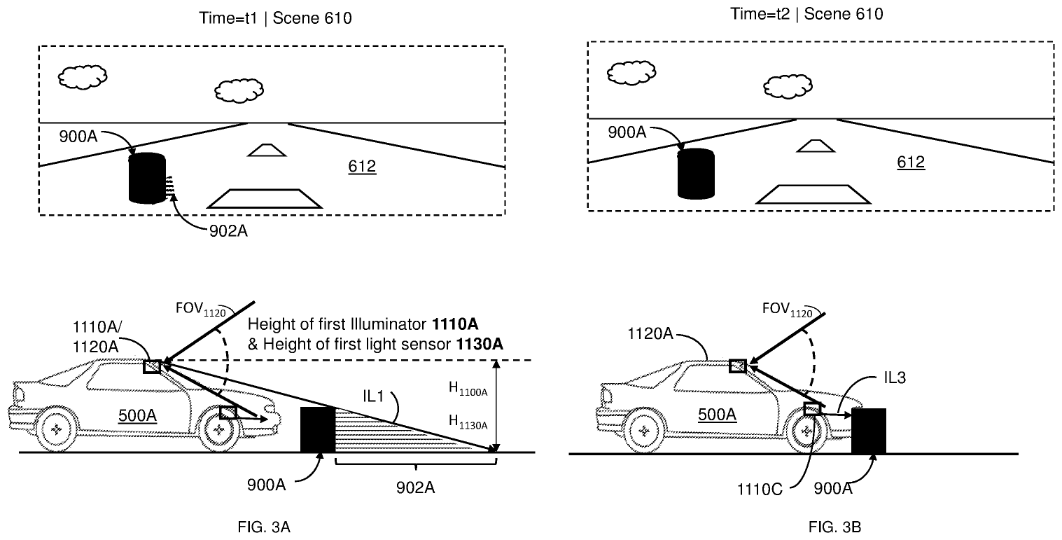

Further reference is made to FIGS. 3A and 3B. Similar to the scenarios exemplified in FIGS. 2A and 2B, FIGS. 3A and 3B shows scenarios in which first scene 610 is illuminated from at least two different illumination directions, while reflections are acquired from at least one image acquisition direction. The first imaging scenario shown schematically in FIG. 3A is exemplified to be identical to the situation schematically shown in FIG. 2A. Accordingly, light sensor 1120A is shown to acquire an image comprising first shadow area 902A.

However, the third imaging scenario schematically shown in FIG. 3B differs from the first imaging scenario shown schematically in FIG. 3A in that another (also: third) illumination direction IL3 of illuminator 1110C is completely blocked or shadowed by first object 900A. Therefore, in the second imaging situation shown in FIG. 3B, the object does not cast a shadow onto driving surface 612 when illuminated by illuminator 1110C.

First object 900A in combination with first shadow area 902A shown in FIG. 3A thus exhibits a contour geometry which is different from the contour geometry of first object 900A imaged in the second imaging situation of FIG. 3B. The two different contour geometries, which are described by the first and second reflection-based image datasets, provide an indication that first object 900A protrudes above ground of driving surface 612. Accordingly, as in the imaging scenario shown in FIGS. 2A and 2B, an analysis of the first and second reflection-based image datasets by scene analysis engine 1200 may result in determining that first object 900A may pose an obstacle, e.g., to vehicle 500A. It is noted that the scenario describes with respect to FIGS. 2A-B and FIGS. 3A-B is also applicable for stationary platforms.

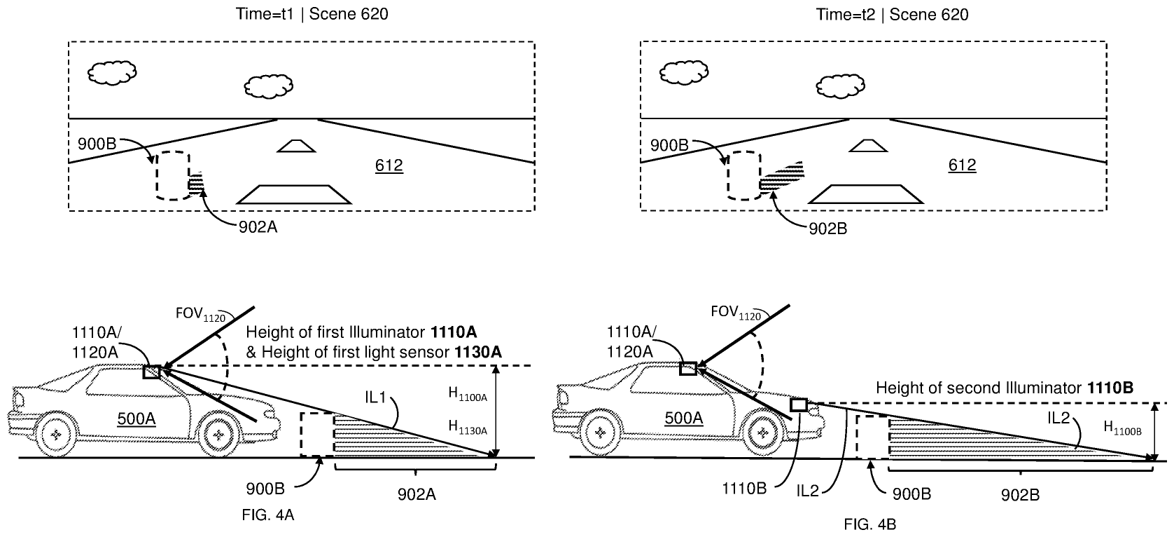

Additional reference is made to FIGS. 4A and 4B. The imaging scenarios shown schematically in FIGS. 4A and 4B for imaging a second scene 620 are identical to the imaging scenarios of FIGS. 2A and 2B, with the difference that second scene 620 comprises a second object 900B which blends with the background thereof. Example scenarios may include a substantially non-reflective object (e.g., black tire) imaged during night; and a bright reflective object (e.g., a white ski suit), imaged against a white reflective background (e.g., snow).

For example, the properties of object 900B and driving surface 612 may be such so that characteristics of light emanating from second object 900B may be (e.g., substantially) identical to the characteristics of light emanating from surface 612 against which second object 900B is imaged. The boundaries of second object 900B are indicated by a dashed line.

First illumination direction is schematically illustrated in FIG. 4A by arrow ILL and second illumination direction is schematically illustrated in FIG. 2B by arrow IL2. The orientation or image acquisition direction is schematically shown by FOV₁₁₂₀. In the example scenario shown in FIG. 4A, a first illuminator 1110A and a first light sensor 1120A are at the same height above ground (also: driving surface) 612, i.e., H_{1110A}=H_{1120A}. First object 900A is exemplified as being non-reflective to light emitted by first and second illuminators 1110A and 1110B.

In the scenario shown in FIG. 4A, illuminating second scene 620 using a first illumination direction causes second non-reflective object 900B to cast first shadow area 902A, schematically illustrated by “horizontal” stripes. As opposed to second object 900B, first and second shadow areas 902A and 902B is distinguishable from driving surface 612. The scene shown schematically in FIG. 4A is imaged by light sensor 1120A to generate a first reflection-based image dataset.

In the scenario shown in FIG. 4B, illuminating second scene 620 using second illumination direction IL2 causes second non-reflective object 900B to cast second shadow area 902B. Second shadow area 902B is distinguishable from surface 612. The scene shown schematically in FIG. 4B is imaged by light sensor 1120A to generate a second reflection-based image dataset.

The first and second reflection-based image datasets generated responsive to illuminating first scene 610 are descriptive of two shadow areas having different contour geometries and which are distinguishable from ground 612, as well as of an object which blends with ground 612. The two different contour geometries of the shadow areas, which are described by the first and second reflection-based image datasets, provide an indication that second object 900B protrudes above ground of driving surface 612. Accordingly, an analysis of the first and second reflection-based image datasets by scene analysis engine 1200 may result in determining that second object 900B may pose an obstacle, e.g., to vehicle 500A.

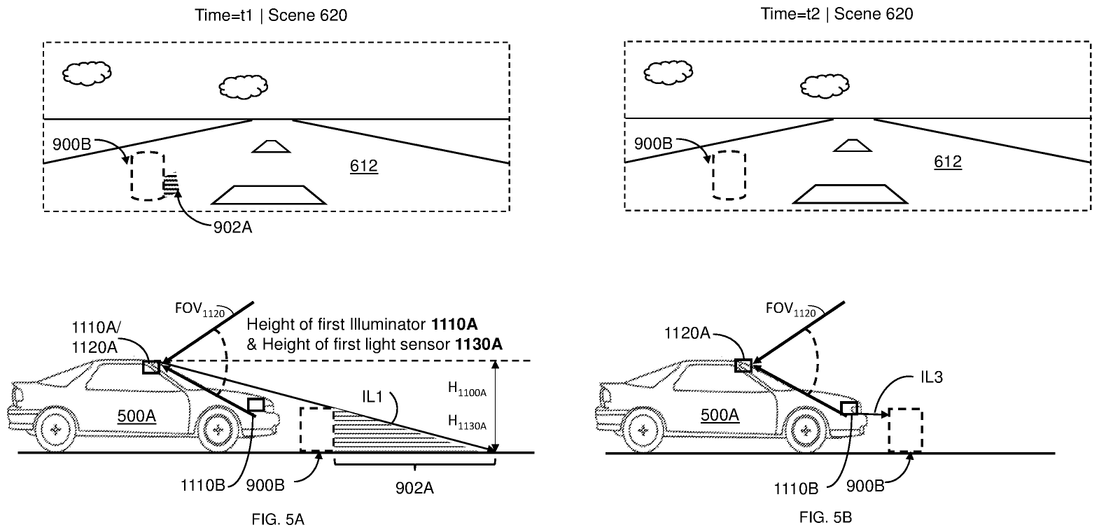

Reference is made to FIGS. 5A and 5B, schematically illustrating an imaging scenario which is identical to the imaging scenario shown in FIGS. 3A and 3B, with the difference that second scene 620 being imaged comprises second object 900B which blends with the background against which the second object is imaged.

In the scenarios shown in FIGS. 5A and 5B, second scene 620 is illuminated from at least two different illumination directions, while reflections are acquired from at least one image acquisition direction. In the first imaging scenario of FIG. 5A, light sensor 1120A is shown to acquire an image comprising first shadow area 902A. The imaging scenario schematically shown in FIG. 5B differs from the first imaging scenario shown schematically in FIG. 3B in that the third illumination direction IL3 is employed so that light emitted by illuminator 1110B is completely blocked or shadowed by second object 900B. Therefore, in the imaging situation shown in FIG. 5B, second object 900B does not cast a shadow onto driving surface 612 when illuminated by illuminator 1110C. Accordingly, only in the situation shown in FIG. 5A, a shadow area is imaged, herein exemplified by shadow area 902A.

The reduction/disappearance (or emergence or increase) of shadow area 902 due to the application of different illumination direction provide an indication that first object 900A protrudes above ground of driving surface 612. Accordingly, an analysis of the first and second reflection-based image datasets descriptive of the two different imaging scenarios exemplified in FIGS. 5A and 5B may result in determining that second object 900B may pose an obstacle, e.g., to vehicle 500A.

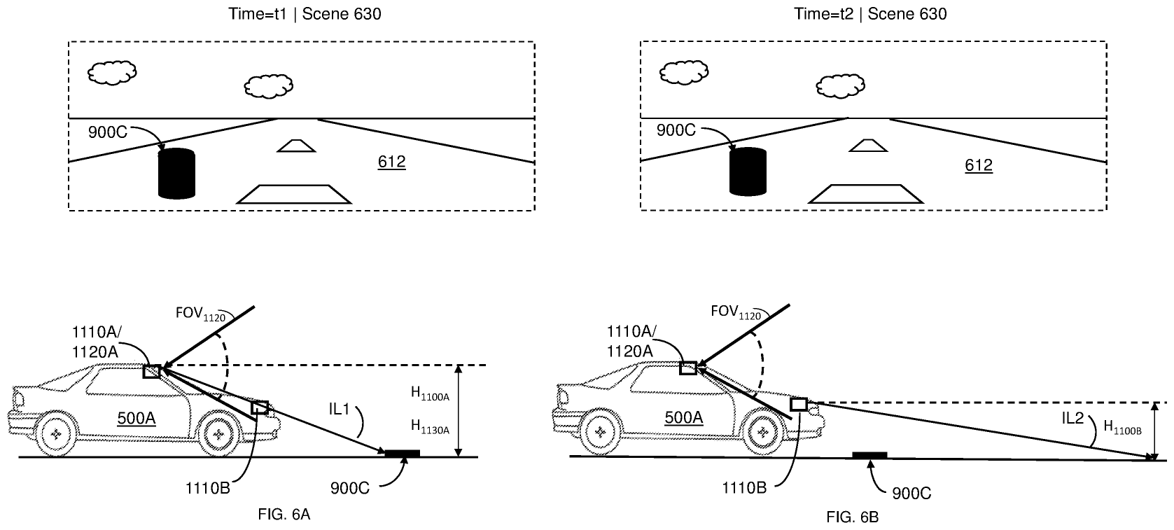

Further reference is made to FIGS. 6A and 6B, exemplifying imaging parameter which are identical to the ones exemplified in FIGS. 2A & 2B, 4A & 4B, and FIGS. 6A & 6B, respectively, with the difference that a third scene 630 which is imaged comprises a third object 900C which does not protrude above driving surface 612. Third object 900C may for example be flush with or overlay driving surface 612 in a manner that does not pose an obstacle to first vehicle 500A engaging with third object 900C. Vehicle 500A may thus drive safely over third object 900C. In the situation shown in FIG. 6B, third object 900C is exemplified as being non-reflective. Hence, non-reflective contour of third object 900C acquired by first light sensor 1120A does not change as a result of illuminating third object 900C from two different directions, exemplified by first and second illumination directions HA (FIG. 6A) and IL2 (FIG. 6B). Such third object 900C can include, for example, an oil spill.

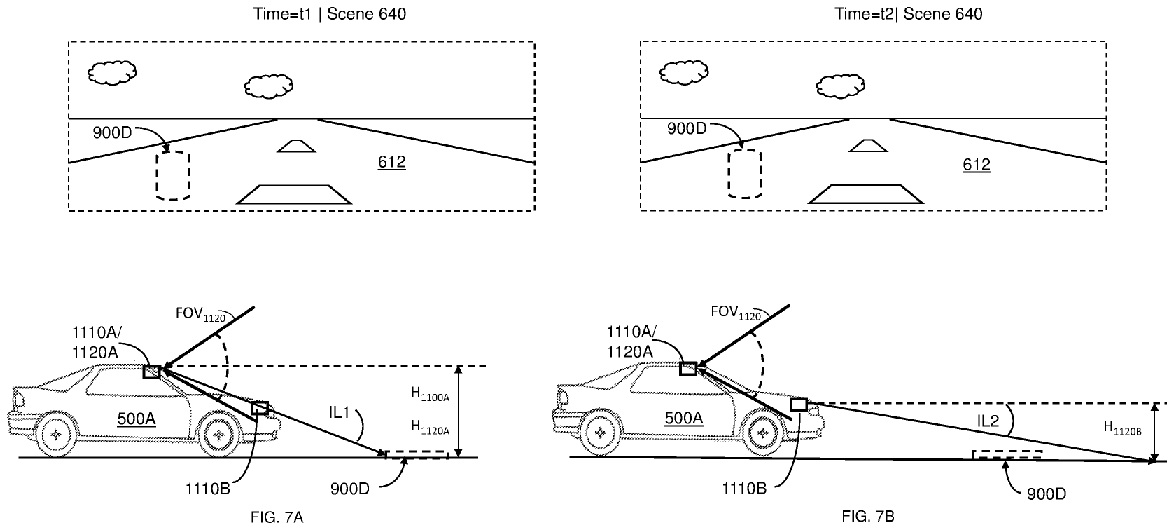

Additional reference is made to FIGS. 7A and 7B. The situation exemplified in FIGS. 7A and 7B is similar to the one shown in FIGS. 6A and 6B, with the difference that rather than being non-reflective, a fourth object 900D being imaged blends with its background of scene 640.

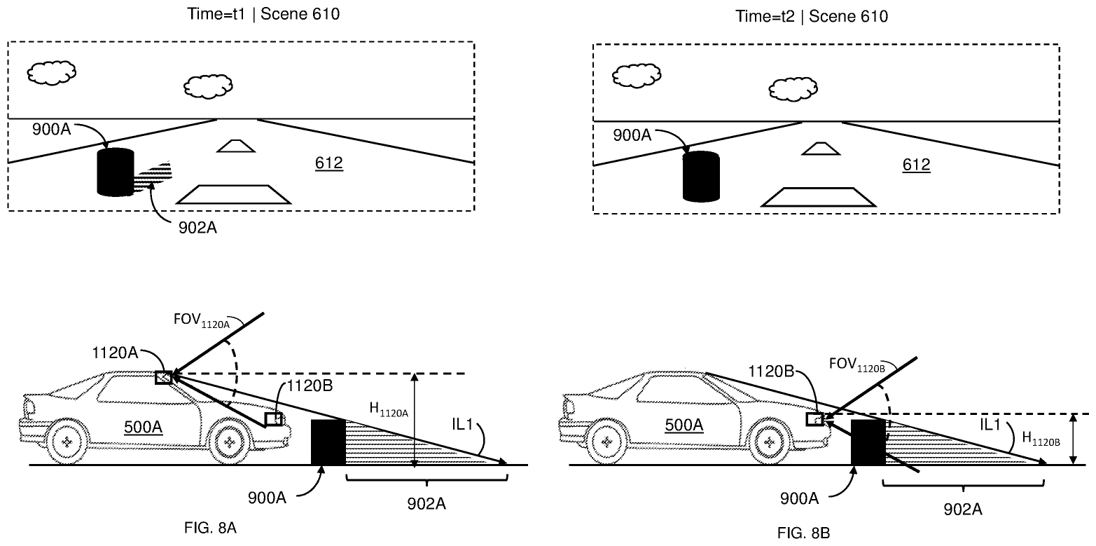

Referring now to FIGS. 8A and 8B, a situation in shown in which first object 900A is illuminated from the same direction IL1 yet imaged from two different directions, exemplified by FOV_{1120A} and FOV_{1120B} of first and second imagers 1120A and 1120B. Due to the employment of different image acquisition directions relative to a given scene illumination direction, imaged reflections received from scene 610 are different from each other. Hence, sets of reflection-based image data are produced which are descriptive of correspondingly different reflections.

In the situation shown in FIG. 8A, at least some of shadow area 902A cast by first object 900A is imaged by the first imager 1120A and therefore falls within the imager's FOV, whereas in the situation shown in FIG. 8B, a shadow area cast by first object 900A does not fall within the FOV of second imager 1120B as it is blocked by first object 900A. Hence, such shadow area is not imaged by second imager 1120B. An analysis of reflection-based image data sets by scene analysis engine 1200 thus returns the detection of a shadow and, therefore, characterizes (e.g., classifies) first object 900A as an “obstacle” for protruding above driving surface 612.

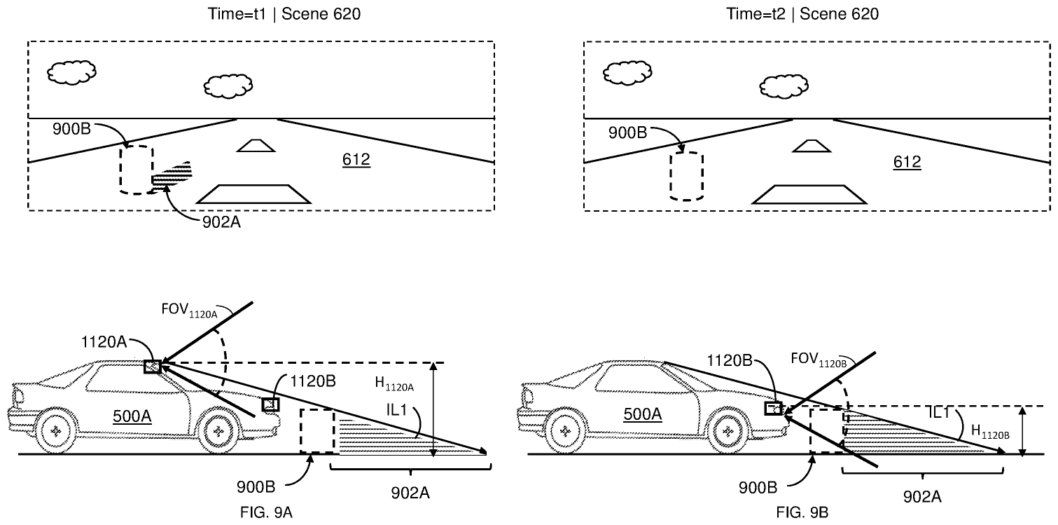

Additional reference is made to FIGS. 9A and 9B, showing a similar situation as in FIGS. 8A and 8B, with the difference that second object 900B of scene 620 being imaged is blending into its surroundings. In the example shown in FIGS. 9A and 9B, second object 900B has similar light-reflecting properties as surface 612. In the situation exemplified in FIG. 9A, shadow area 902A falls within first FOV_{1120A} of first imager 1120A, whereas in the situation exemplified in FIG. 9B, shadow 902A cast by second object 900B does not fall within second FOV_{1120B} of second imager 1120B. Two reflection-based image datasets may thus be produced which are descriptive of different reflections, one set being descriptive of shadow area 902B and another set no being descriptive of such shadow area. An analysis of reflection-based image data sets by scene analysis engine 1200 thus returns the detection of a shadow and, therefore, classify second object 900B as an “obstacle” for protruding above driving surface 612.

In the Examples shown in FIGS. 3A-B, 4A-B, 5A-B, 6A-B, 7A-B, 8A-B and 9A-B, the two illuminators or the two imagers are positioned at some distance from one another (e.g., different heights above ground), i.e., the pair of illuminators or pair of imagers are not co-located. In some examples, with respect to the world coordinate system, the two illuminators may be located on a plane which is perpendicular to the ground.

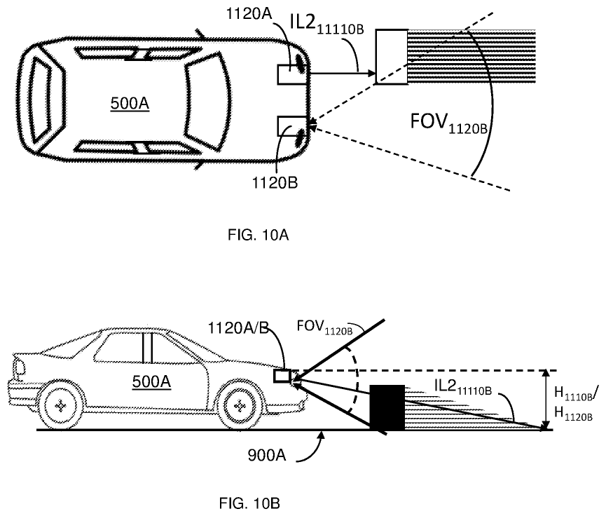

In some embodiments, as schematically illustrated in FIGS. 10A and 10B, two imagers 1120A and 1120B may be positioned at the same height above ground and positioned laterally apart (parallax) from one another.

In some examples, the two imagers may be laterally spaced apart from each other (parallax). In some examples, with respect to a world coordinate system, the two imagers may be on a plane parallel to the ground.

Analogously, in some embodiments, two illuminators may be positioned at the same height above ground but be laterally positioned apart (parallax) from one another.

It is noted that in some embodiments, two illuminators may be positioned at different heights with a lateral distance from each other. In some embodiments, two imagers may be positioned at different heights with a lateral distance from each other.

In some embodiments, a selected illuminator and a selected imager may be arranged relative to each other such that a shadow cast by an object or change in the shadow, in response to illuminating the object with the selected illuminator, cannot be detected by the selected imager. For example, the optical axis of the selected illuminator may be arranged to coincide (also: substantially coincide) with the optical axis of the selected imager of the system. The selected illuminator and imager may thus be on-axis (also: substantially on-axis) with respect to each other to form an on-axis imager-illuminator couple.

Since no shadow or change thereof can be detected when illuminating and concurrently imaging the object with the on-axis imager-illuminator couple, the latter may be employed to detect false positive “shadow” detections originating, in fact, from black (also: substantially black) surfaces.

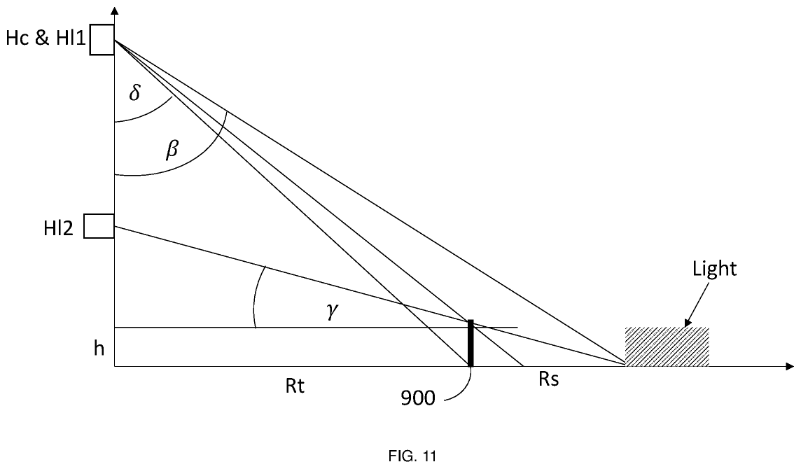

Additional reference is made to FIG. 11. In some embodiments, a distance between an object protruding above ground and an imager may be determined, as described below:
Hc—height of camera and first illuminator above ground
Hl—height of second illuminator above ground
h—object height above surface
Rt—distance from platform to object
Rs—length of shadow generated from Hl2

The following two angles are measured: δ, β

Assumption: flat surface

$$Rs = \frac{h}{tan γ} \qquad Equation 1$$

$$tan γ = \frac{Hl 2 - h}{Rt} \qquad Equation 2$$

$$Rs = \frac{h}{( Hl 2 - h ) Rt} \qquad Equation 3$$

$$Rt = \frac{( Hl 2 - h )}{h} R \qquad Equation 4$$

$$\frac{Rt + Rs}{Hc} = tan β \qquad Equation 5$$

$$\frac{Rt}{Hc} = tan δ \qquad Equation 6$$

Considering the three equations 4-6, it is possible to solve for the three unknown variables Rt, Rs and h.

Table 1 below lists the various options for implementing shadow-detection based ROI or object characterization:

| | | | ROI CHARACTERIZATION |
|---|---|---|---|
| | EXAMPLE SETUP: | OPERATION: | CAPABILITIES: |
| Option 1 | 1 imager and | Platform can be stationary or in | Provides increased contrast of an |
| | 1 illuminator | movement, and at time t1 scene | object against its background. |
| | at some distance | is imaged without illumination | Increased contrast improves the |
| | from each other | and at t2, where t2 > t1, with | visibility of object edges, thereby |
| | (parallax) | illumination | facilitating range calculation. |
| Option 2 | 1 imager and two or | Platform can be stationary or in | Provides increased contrast of an |
| | more illuminators | movement. While the object is | object against its background. |
| | which are arranged | sequentially illuminated by the | Increased contrast improves the |
| | at some distance | two or more illuminators from | visibility of object edges, thereby |
| | from each other (e.g., | different directions, a plurality | facilitating range calculation. |
| | parallax) | of images is acquired. | Determining whether an object |
| | | Optionally, the object may be | in the ROI protrudes above |
| | | sequentially illuminated by a | ground by comparing at least |
| | | plurality of sets of illuminators, | two of the plurality of images |
| | | i.e., a first set of illuminators | with each other to investigate |
| | | illuminates the scene at t1 and a | whether the object casts a |
| | | second set of illuminators | shadow or not |
| | | illuminates the scene at t2, | Range estimation of the platform |
| | | where t2 > t1. Images of the | from an object protruding above |
| | | object are acquired while the | ground and casting different |
| | | object is being illuminated by | shadows in at least two of the |
| | | the plurality of sets of | plurality of images |
| | | illuminators. | |
| Option 3 | At least 2 imagers at | Platform can be stationary or in | Provides increased contrast of an |
| | different positions | movement, and the object scene | object against its background. |
| | from each other and | is being imaged from two | Increased contrast improves the |
| | at least 1 illuminator | different acquisition angles (at | visibility of object edges, thereby |
| | | least) while being illuminated | facilitating range calculation. |
| | | from the same direction | Determining whether an object |
| | | | in the ROI protrudes above |
| | | | ground by comparing at least |
| | | | two of the plurality of images |
| | | | with each other to investigate |
| | | | whether the object casts a |
| | | | shadow or not |
| | | | Range estimation of the platform |
| | | | from an object protruding above |
| | | | ground and casting different |
| | | | shadows in at least two of the |
| | | | plurality of images |
| Option 4 | A) 1 imager and | Platform can be stationary or in | The on-axis illuminator never |
| | multiple illuminators | movement. While the object is | generates a shadow. Therefore, |
| | (or more) which are | sequentially illuminated by the | on-axis object illumination and |
| | arranged at some | two or more illuminators from | image acquisition can be used to |
| | distance (e.g., | different directions, a plurality | cancel false positive “shadows” |
| | parallax) from each | of images is acquired. | originating from black surface on |
| | other and where one | Optionally, the object may be | the road. |
| | illuminator axis | sequentially illuminated by a | |
| | coincides or | plurality of sets of illuminators, | |
| | substantially | i.e., a first set of illuminators | |
| | coincides with the | illuminates the scene at t1 and a | |
| | imager's optical axis. | second set of illuminators | |
| | B) analogous as | illuminates the scene at t2, | |
| | under a) but with 1 | where t2 > t1. Images of the | |
| | illuminator and a | object are acquired while the | |
| | plurality of imagers | object is being illuminated by | |
| | with 1 imager being | the plurality of sets of | |
| | on-axis with the | illuminators. | |
| | illuminator | In addition, on-axis illumination | |
| | | is performed separately to | |
| | | determine the object's | |
| | | boundaries | |

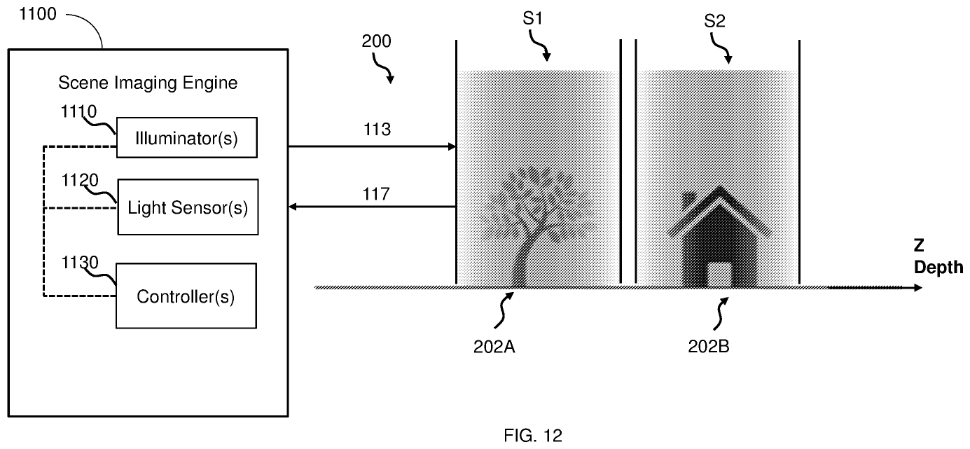

As noted above, gated and/or non-gated imaging may be employed for the purpose of object characterization (e.g., shadow-detection), for example, when implementing any of the options referred to in Table 1. Referring to FIG. 12, scene imaging engine 1100 of ODI system 1000 may be configured to selectively image one or more DOFs, herein exemplified by slice S1 and slice S2, by illumination of a scene with light 112, and to perform acquisition of responsively received reflections 117, in timed coordination with the illumination of the scene.

In some examples, gating may be performed using gating operation parameter values such to obtain two or more slices that are non-overlapping or at least partially overlapping to obtain one or more overlap regions.

In some examples, two DOFs imaged by a platform may extend in different directions relative to a reference coordinate system for imaging an object from different angles.

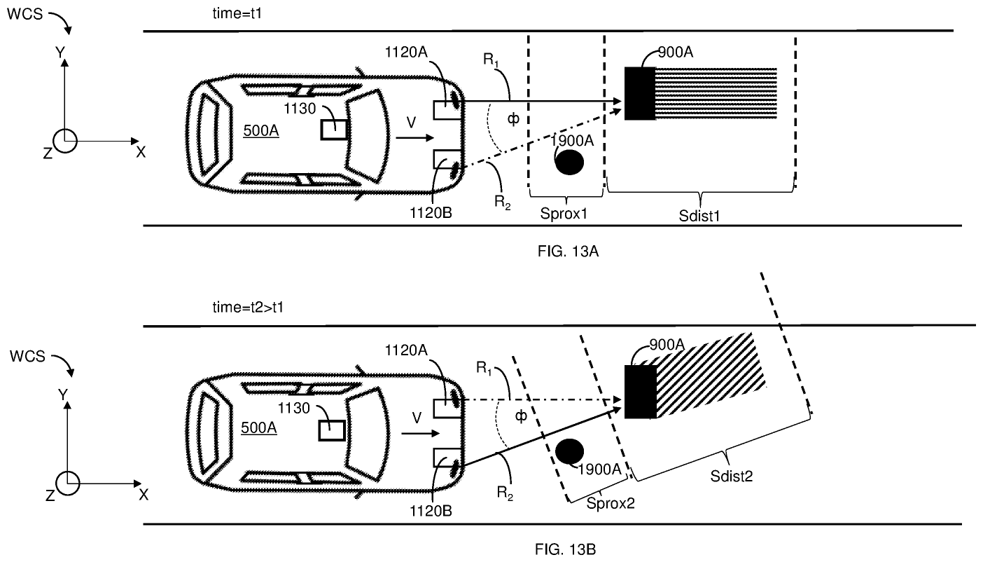

For example, as schematically shown in FIG. 13A, a first proximal DOF Sprox1 and a first distal DOF Sdist1 both extend along a same first main direction R₁ relative to an orientation of vehicle 500A relative to a reference frame (e.g., world coordinate system WCS). Furthermore, as schematically shown in FIG. 13B, a second proximal DOF Sprox2 and a second distal DOF Sdist2 extend along a same second main direction R₂, different from the first main direction R₁.

The first main direction R₁ and the second main direction R₂ form an angle ϕ therebetween, as schematically illustrated in FIGS. 13A and 13B.

For illustrative purposes only, without being construed as limiting, first main direction R₁, is shown to coincide with a vehicle driving direction V.

In the illustrated examples, an object such as first object 900A may be imaged, while not imaging an object 1900A outside the two distal DOFs Sdist1 and Sdist2. The terms “proximal” and “distal” are used in relation to vehicle 500A.

In some embodiments, the different proximal DOFs shown in FIGS. 13A and 13B may differ from each other only with respect to their DOF expansion angle relative to each other. In some other embodiments, the different proximal DOFs shown may also differ regarding the ranging distance and/or other gated imaging parameter values. In some embodiments, the different distal DOFs shown in FIGS. 13A and 13B may differ from each other only with respect to their DOF expansion angle relative to each other. In some other embodiments, the different distal DOFs shown may also differ regarding the ranging distance and/or other gated imaging parameter values.

A plurality of DOFs may be sequentially imaged. Two different DOFs expanding in different directions but otherwise having identical DOF imaging parameter values may be concurrently or alternatingly imaged. Two different DOFs expanding in different directions and also having identical DOF imaging parameter values may be concurrently or alternatingly imaged.

In FIGS. 13A and 13B, “active” directions along which a scene DOF is shown to be imaged is schematically illustrated by vectors R with a “solid line” compound type, whereas the “inactive” scene DOF directions are schematically illustrated by “dash-dot” compound type.

In some embodiments, at least two different pixel subsets may be employed for imaging an object illuminated from different illumination directions. For example, a first pixel subset may be employed for imaging the object under the first distal DOF Sdist1, and a second pixel subset, different from the first pixel subset, may be employed for imaging the same object under the second distal DOF Sdist2 schematically shown in FIG. 13B. Further details of how gated imaging using different pixel subsets may be performed are disclosed in PCT/IB2016/057853.

In some embodiments, ODI system 1000 may also be configured to determine depth information (also: depth range information or depth range maps) of a scene region (e.g., an object's shape and/or the object's distance from a reference point, etc.) of an object being illuminated from at least two different directions. Further details of how depth information of an object may be obtained are disclosed in PCT application PCT/IB2016/057853.

For example, as shown in FIGS. 13A and 13B, the two distal DOFs are at least partially overlapping due to their extension along different directions R1 and R2, resulting in corresponding different gating profiles that may be obtained for the respective distal DOFs. Based on the reflections received from the different overlapping distal DOFs depth information of an object located in the overlapping DOF region of the scene may be determined. In some examples, an object in the scene may be characterized based on both depth information and shadow-related characteristics, for example, to reduce the probability of or to eliminate false-positive shadow detections.

In some embodiments, different gating patterns may be employed for imaging a scene to analyze reflections from objects in the scene, based on pattern changes received from the scene at different depth ranges, as described in PCT application PCT/IL2016/050770.

In some examples, an object in the scene may be characterized based on data or information derived from analyzing (reflected) pattern changes and further based on determined shadow-related characteristics, for example, to derive fused image data with respect to a selected DOF.

In some examples, data descriptive of at least one shadow-related characteristic, and data descriptive of pattern change(s) and data depth information may be fused or other otherwise be used for characterizing an object in the scene, for example, to reduce the probability of or to eliminate false-positive shadow detections.

In some embodiments, an object-related characteristic may be determined by illuminating the object from at least one first direction and acquiring image data of the illuminated object from the at least one first direction without employing gated imaging (i.e., using non-gated active illumination and imaging), and further by imaging the same object with a DOF extending in a second direction using gated imaging, the at least one first illumination direction being different from the second extension direction of the DOF. Acquiring image data of the illuminated object actively illuminated from at least one first illumination direction without employing gated imaging (i.e., in a non-gated imaging manner), and further acquiring image data of the illuminated object using gated imaging of a DOF extending in the second direction, may be performed concurrently or sequentially (including, e.g., alternatingly). The DOF may extend in a second direction different from the first illumination direction due to gated illumination and/or gated light reflection acquisitions resulting in imaging a scene DOF extending along a second main direction which is different from the first illumination direction.

In some embodiments, analogous to what is described herein with respect to FIGS. 13A and 13B, performing gated and non-gated imaging may be performed for determining an object-related characteristic by illuminating the scene from one direction and acquiring reflections from the scene from two or more directions (e.g., by employing two or more image sensors mounted on the platform).

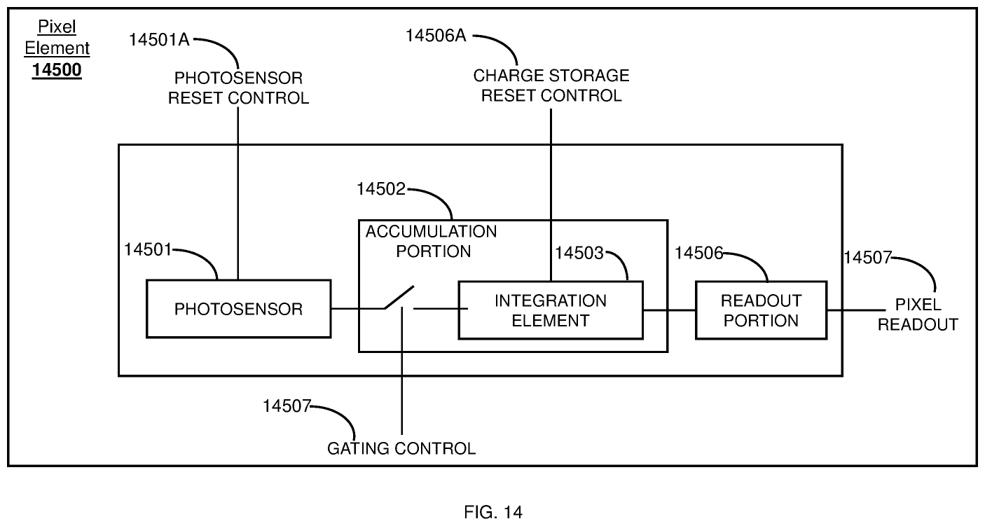

Additional reference is made to FIG. 14, which is a schematic functional block diagram illustration of the components of a pixel element 14500, according to some embodiments.

As schematically shown in FIG. 14, pixel element 14500 can comprise a photosensor 14501 that is connected via a gating control 14504 to an integration element 14503 (also: memory storage). Gating control 14504 and integration element 14503 may be parts of an accumulation portion 14502. Gating control 14504 may comprise multiple gate arrays and/or transistors to control signal transfer from pixel photosensor 14501 to integration element(s) 14503. An accumulated signal is delivered to a readout portion 14506 which provides pixel readout 14507. Photosensor 14501, accumulation portion 14502 and integration element 14503 may be reset. For example, a charge storage reset control 14506A may reset integration element 14503.

Integration element 14503 may comprise multiple elements (not illustrated) within the pixel element 14500 whereas a portion of the accumulated signal (e.g. ambient light as described in step 12052) is stored by at least one selected integration element of the multiple integration elements and another portion of the accumulated signal (e.g. ambient light and light source reflected light as described in steps 12100-12300) is stored by at least one other selected integration element of the multiple elements. Photosensor 14501 outputs a signal indicative of an intensity of incident light. Photosensor 14501 is reset by inputting the appropriate photo sensor reset control signal from a photosensor reset control 14501A. Photosensor 14501 may be any of the following types: photodiodes, photogates, metal-oxide semiconductor (MOS) capacitors, positive-intrinsic-negative (PIN) photodiodes, pinned photodiodes, avalanche photodiodes, visible range to short wave infrared range (SWIR) photodiodes (incorporating, e.g., any of silicon, germanium, indium gallium arsenide, indium aluminum arsenide, indium phosphide, lead sulfide, mercury cadmium telluride, etc.) or any other suitable photosensitive element. Some types of photosensors may require changes in the pixel structure and/or processing methods (for example for a hybrid structure using indium bumps). Accumulation portion 14502 performs gated accumulation (i.e., accumulates intervals of sub-exposures prior to the signal readout) of the photo sensor output signal over a sequence of time intervals. The accumulated output level may be reset by inputting a pixel reset signal into accumulation portion 14502 by a reset transistor (not shown). The timing of the accumulation time intervals may be controlled by a gating control signal, described below, that may be controlled externally (outside light sensor 1120), internally (within light sensor 1120) or partially externally and partially internally.

During the period when a camera sensor is not exposed (i.e., while the light pulse may still be propagating through the atmosphere), the sensor ideally does not accumulate any photons. But in practice, a certain level of residual light may still enter the light sensor or be accumulated by the light sensor (i.e., signal charge can be stored in the memory node without being contaminated by parasitic light). This phenomenon of “leakage photons”, which may be referred as Parasitic Light Sensitivity (PLS), is especially problematic in CMOS sensors, where it is difficult to mask the memory node (MN) and floating diffusion in the pixel level sensor (typical masking approaches include: micro-lens focusing light away from the MN, metal layers above the MN, potential attracting the photoelectrons to the photodiode, and potential barriers around the MN). PLS is a function of the overall pixel exposure time and readout time. The pixel element can exhibit a high PLS value of, for example, at least 1000. The above noted pixel architecture may be employed in association with an off-chip memory (not shown) to save data of a previous image frame.

The expression “off-chip” may refer to components, modules and/or blocks that are not integrally formed with light sensor 1120, as opposed to “on-chip”.

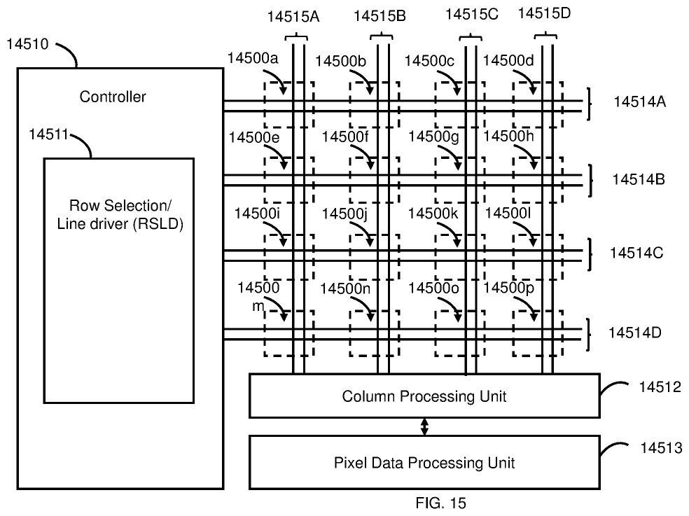

Further reference is made to FIG. 15. According to some embodiments, light sensor 1120 comprises an m×n array of pixel elements 14500 arranged in m rows and n columns. Optionally, light sensor 1120 comprises m optically-black (OB) pixel rows and n optically-black (OB) pixel columns. Optionally, light sensor 1120 comprises k special rows (not shown) such as, for example, a reference row (not shown) for generating a reference voltage and/or a test row (not shown) used for debugging purposes. Optionally, the pixel pitch (the distance between the geometric centres of adjacent pixels elements) may be 10 μm or less.

Light sensor 1120 can comprise an on-chip controller 14510 that includes a row selection/line driver (RSLD) 14511 according to which pixel elements 14500 (e.g., active pixels or pixel elements 14500a-14500p) are controllably selected. In an embodiment, functions of on-chip controller 14510 are coordinated with controller 1130 of scene imaging engine 1110 shown in FIG. 1. Optionally, controller 1130 provides control signals to on-chip controller 14510, which then controllably selects pixel elements 14500 accordingly. Pixel control signals for the controlling of pixel elements 14500 are provided from on-chip controller 14510 to pixel elements 14500 via control signal lines 14514. A plurality of pixel elements (e.g., of a row) may communicate with on-chip controller 14510 via the same control signal line 14514. In other words, a plurality of pixel elements (e.g., of a row) may share the same control signal line, e.g., as schematically illustrated in FIG. 15. For example, four pixel elements (pixel elements 14500a-14500d) may communicate with controller 14510 via the same control signal line 14514 (e.g., control signal line 14514A). Pixel signals produced by pixel elements 14500 are provided to pixel data processing unit 14513 via pixel signal readout channels 14515 for further processing by a pixel data processing unit 14513, e.g., as part of the readout channel.

Optionally, pixel signals may be provided and processed column-by-column or column-wise by a column processing unit 14512. For instance, a column selection may be made by controller 14510 and pixel signals of the selected column are provided to column processing unit 14512 column-wise via readout channels 14515. In other words, a column of pixel elements 14500 provides pixel signals via the same readout channel. For instance, pixel signals produced by pixel elements 14500a, 14500e, 14500i and 14500m are readout by column processing unit 14512 via readout channel 14515A. Optionally, light sensor 1120 may comprise m readout channels (not shown) for column-wise readout of signals of optically black pixel.

Column processing unit 14512 processes (e.g., converts) the column-wise obtained signals to obtain pixel signals that are respectively associated with the individual pixel elements 14500, and which are then further processed by pixel data processing unit 14513.

In an embodiment, column-wise readout of pixel signals can be performed in parallel via readout channels 14515, i.e., simultaneously. More specifically, the pixel signals of n sets of pixel elements of respective n columns may be read out in parallel. For example, pixel signals of readout channels 14515A—14515D may be read out in parallel, as opposed to a sequential read out procedure. In another embodiment, column-wise produced pixel signals may be readout sequentially via readout channels 14515, e.g., readout channels 14515A-14515D may be sequentially selected for readout.

When operating or reading out the “column” pixel signals in parallel, the pixel signals of an entire row of pixel elements may be processed simultaneously, e.g., to perform row-by-row A/D conversion of the pixel signals. For example, pixel signals of pixel elements 14500m, 14500n, 14500o and 14500p are readout in parallel, and then simultaneously processed by column processing unit 14512. The time required for reading out in parallel the pixel signals of a row of pixel elements and for digitizing the same readout pixel signals of the can be referred to as “row conversion time” or “row time”.

According to some embodiments, light sensor 1120 may comprise additional on-chip circuitry for implementing various functional modules, blocks and/or units, for example, for controlling on-chip components of light sensor 1120, for controlling the interaction of off-chip components of light sensor 1120, for controlling the generation of data frames for high-speed digital outputs (e.g., according to MIPI, LVDS and/or other standards, protocols, platforms, and/or techniques). For instance, light sensor 1120 may include a sensor control module (not shown) the controlled generation of pixel signals. Such sensor control module may include controller 14510 and RSLD 14511.

Optionally, light sensor 1120 includes a serialization module (not shown), for serializing out digitized pixel signals (also: pixel data) to a framing module (not shown). The framing module (not shown) receives the pixel data from the Serialization block (not shown), generates a digital frame, and transmits the digital frame out via digital ports (e.g., MIPI, LVDS etc.). The frame module (not shown) may also generate a clock recovery signal and synchronization codes.

Optionally, light sensor 1120 includes communication interface modules (not shown) that relate to input/output signals communication interfaces such as, for example, serial peripheral interface (SPI) bus, external control signals and/or data output. The pixel data may for example be outputted through digital ports. A pixel data output interface may for example comprise at least 2 LVDS data ports plus 1 extra port for clock recovery. Optionally, synchronization data is interleaved with the pixel data.

Optionally, light sensor 1120 includes auxiliary on-chip modules (not shown) that may be employed for reducing the number of external components required for the operation of light sensor 1120. Such auxiliary on-chip modules (not shown) may for example implement Power-on-Reset, a Temperature Sensor (Optional), a Clock Generation Module with a low-jitter low-power Phase Locked Loop (PLL), and/or a Reference Voltage Generator with a high-accuracy band-gap.

It is noted that although some embodiments are disclosed herein in conjunction with the gated imaging of DOFs through the sub-exposure of pixel elements 14500 of light sensor 1120 (e.g., sequentially exposing the pixel subsets of a group of subsets), this should by no means be construed as limiting. For example, the procedure for reducing or minimizing multipath reflection artifacts may also be employed when all pixel elements of light sensor 1120 are exposed, at the same time, to reflected light and the pixel values of each DOF are read out in separate frames.

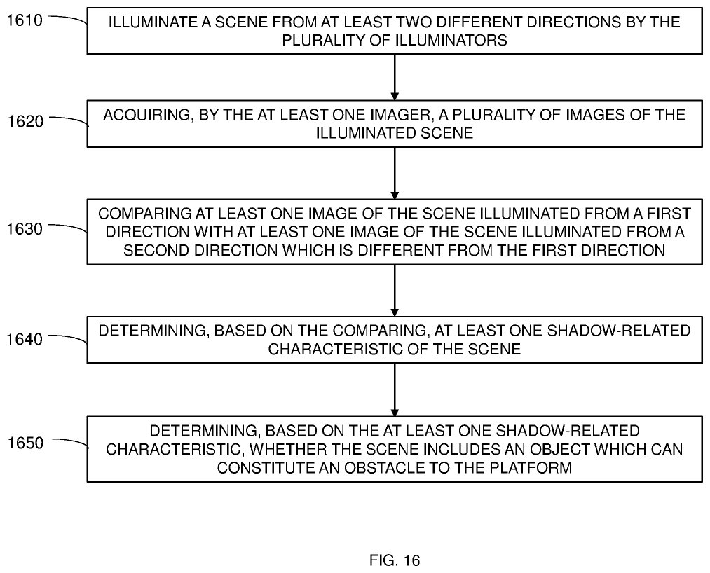

Additional reference is made to FIG. 16. A method for determining an object-related characteristics including, for example, detecting an obstacle to the platform in a scene, may comprise in some embodiments, as indicated by block 1610, illuminating the scene from at least two different directions by the plurality of illuminators.

In some embodiments, the method may further include acquiring, by the at least one imager, a plurality of images of the illuminated scene (block 1620).

In some embodiments, the method may include comparing at least one image of the scene illuminated from a first direction with at least one image of the scene illuminated from a second direction which is different from the first direction (block 1630).

In some embodiments, the method may further include determining, based on the comparing, at least one shadow-related characteristic of the scene (block 1640).

In some embodiments, the method may include determining, based on the at least one shadow related characteristic, whether the scene includes an object which can constitute an obstacle to the platform (block 1650).

In some embodiments the system may be configured to detect at least one object-related characteristic by illuminating the scene from at least one direction and by acquiring reflected a plurality of scene images from at least two directions (e.g., by employing two or more image sensors).

### Additional Examples

In some examples, a system employed by a platform for determining at least one object-related characteristic in a scene, (e.g., detecting an obstacle to the platform in a scene), comprises a plurality of illuminators arranged at different locations of the platform; at least one imager; a processor; and a memory configured to store data and software code executable by the processor to perform the following: illuminating the scene from at least two different directions by the plurality of illuminators; acquiring, by the at least one imager, a plurality of images of the illuminated scene; comparing at least one image of the scene illuminated from a first direction with at least one image of the scene illuminated from a second direction which is different from the first direction, e.g. to obtain at least one comparison result; determining, based on the comparing (e.g., based on the at least one comparison result(s)), at least one shadow-related characteristic of the scene; and determining, based on the at least one shadow-related characteristic, whether the scene includes an object which can constitute an obstacle to the platform.

In some examples, a system employed by a platform for detecting an obstacle to the platform in a scene, comprises a processor; and a memory configured to store data and software code portions executable by the processor to perform the following:
acquiring, by a plurality of imagers, a plurality of images of a scene comprising at least one region of interest (ROI) from at least two different directions, wherein at least one of the plurality of images is acquired while the ROI is actively illuminated by at least one illuminator;
comparing at least one first image of the actively illuminated scene acquired from a first direction with at least one second image of the actively illuminated scene acquired from at least one second direction which is different from the first direction; determining, based on the comparing, a shadow-related characteristic of the at least one ROI; and determining, based on the shadow-related characteristic, whether the imaged at least one ROI includes an object which can constitute an obstacle or not to a moving platform in the scene.

In some examples, the system is configured to image at least one selected depth-of-field of the scene by employing gated imaging.

In some examples, the at least one shadow-related characteristic of the scene pertains to the at least one selected depth-of-field.

In some examples, the system is configured to determine at least one shadow-related characteristics for a plurality of two different depth-of-fields of the scene.

In some examples, the determining of the at least one shadow-related characteristic includes determining a direction and/or size of a shadow in the scene.

In some examples, the system is configured to perform, based on the determined at least one shadow-related characteristic, one of the following: determining whether the scene includes an object that protrudes from a ground surface, or a background surface; determining a distance between the at least one imager and an object in the scene; determining a distance between the object in the scene and the platform; increasing contrast of an object located in the scene; or any combination of the aforesaid.

In some examples, determining the at least one shadow-related characteristic comprises classifying an object in the scene as one of the following: “obstacle” or “non-obstacle”.

In some examples the plurality of illuminators is activated simultaneously; activated alternatingly during non-overlapping time periods; or activated in at least partially overlapping time periods.

In some examples, the at least one illuminator and imager are arranged such that a shadow cast by an object in the scene cannot be imaged by the at least one imager, for identifying scene regions which are associated with false-positive shadows.

In some examples, the system is configured to determine, based on the acquired images: at least two candidate ROIs of the imaged scene; a shadow-related characteristic of each of the at least two candidate ROIs; and based on the shadow-related characteristics of each of the two candidate ROIs, whether any of the at least two candidate ROIs comprises an object that can constitutes an obstacle to a moving platform; and is further configured to provide an output descriptive of the characteristics of the at least two candidate ROIs.

In some examples, actively illuminating the scene comprises: simultaneously emitting light from at least one first and the at least one second illuminator of the plurality of illuminators, wherein light emitted from the at least one first illuminator has different characteristics than light emitted from the at least one second illuminator; and differentiating between the plurality of acquired images based on the characteristics of the light emitted by the at least one first and the at least second illuminator.

In some examples, characteristics of light comprise one of the following: a wavelength; light polarization; a phase difference; data encoded in the light; amplitude; or any combination of the aforesaid.

In some examples, the system is configured to actively illuminate the scene with pulsed light generated by at least one of the plurality of illuminator; receiving, responsive to illuminating the scene with the pulsed light, reflections on at least one light sensor that comprises a plurality of pixel elements; and gating at least one of the plurality of pixel elements of the at least one imager for converting the reflections into pixel values for generating reflection-based image data that is descriptive of at least one depth-of-field (DOE) range.

In some examples, the gating of the plurality of pixel elements is performed for selectively acquiring reflections produced with respect to the plurality of different illumination positions.

In some examples, acquiring reflections comprises wavelength filtering to selectively acquire reflections with respect to the plurality of different illumination positions.

In some examples, the system is configured to post-process reflection-based image data to produce a plurality of reflection-based image data sets descriptive of reflected light acquired by the imager responsive to illuminating the scene from the plurality of illumination positions.

In some examples, a method for detecting an obstacle to a platform in a scene comprises actively illuminating a scene from at least two different directions by a plurality of illuminators of the platform, wherein the plurality of illuminators are arranged at different locations of the platform; acquiring, by at least one imager of the platform, a plurality of images of the illuminated scene; comparing at least one image of the scene illuminated from a first direction with at least one image of the scene illuminated from a second direction which is different from the first direction, e.g. to obtain a comparison result; determining, based on the comparing (e.g., based on the at least one comparison result(s)), at least one shadow-related characteristic of the scene; and determining, based on the at least one shadow-related characteristic, whether the imaged scene includes an object which can constitute an obstacle to the platform.

In some examples, determining the at least one shadow-related characteristic includes determining a direction and/or size of a shadow in the scene.

In some examples, the method comprises performing, based on the determined at least one shadow-related characteristic, one or more of the following: determining whether the scene includes an object that protrudes from a ground surface or background surface; determining a distance between the at least one imager and an object of interest in the scene; determining a distance between an object of interest and the moving platform; increasing contrast of an object of interest.

In some examples, determining the at least one shadow-related characteristic comprises classifying the at least one ROI as one of the following: “obstacle” or “non-obstacle”.

In some examples, the plurality of illuminators is activated simultaneously; activated alternatingly during non-overlapping time periods; or activated in at partially overlapping time periods.

In some examples, the method comprises illuminating the scene with at least one illuminator; and acquiring an image of the illuminated scene with at least one imager; wherein the at least one illuminator and the at least one imager are arranged on the platform such that a shadow cast by an object in the scene cannot be imaged by the at least one imager, to identify scene regions which are associated with false-positive shadows.

In some examples, the method comprises determining, based on the acquired images: at least two candidate ROIs of the imaged scene; a shadow-related characteristic of each of the at least two candidate ROIs; and, based on the shadow-related characteristics of each of the two candidate ROIs, whether one or more of the at least two candidate ROIs comprises an object that can constitutes an obstacle to a moving platform; and providing an output descriptive of the characteristics of the at least two candidate ROIs.

In some examples, actively illuminating the scene comprises: simultaneously emitting light from at least one first and the at least one second illuminator of the plurality of illuminators, wherein light emitted from the at least one first illuminator has different characteristics than light emitted from the at least one second illuminator; and differentiating between the plurality of acquired images based on the characteristics of the light emitted by the at least one first and the at least second illuminator.

In some examples, acquiring an image of a scene comprises: gating a plurality of pixel elements of the at least one imager for selectively acquiring reflections from different depth-of-fields (DOFs).

In some examples s, the gating of the plurality of pixel elements is performed for selectively acquiring reflections produced with respect to the plurality of different illumination positions.

In some examples, acquiring reflections comprises wavelength filtering to selectively acquire reflections with respect to the plurality of different illumination positions.

In some examples, acquiring reflections comprises post-processing of reflection-based image data to produce a plurality of reflection-based image data sets descriptive of reflected light acquired by the imager responsive to illuminating the scene from the plurality of illumination positions.

In some examples, the method comprises imaging at least one selected depth-of-field of the scene by employing gated imaging.

In some examples, the at least one shadow-related characteristic of the scene pertains to the at least one selected depth-of-field.

In some examples, the method includes determining at least one shadow-related characteristics for a plurality of two different depth-of-fields of the scene.

In some examples, a system employed by a platform for detecting an obstacle to the platform comprises: a processor; and a memory configured to store data and software code portions executable by the processor to perform the following: illuminating the scene from at least two different directions by the plurality of illuminators; acquiring, by a plurality of imagers, a plurality of images of the illuminated scene; comparing at least one image of the scene illuminated from a first direction with at least one image of the scene illuminated from a second direction which is different from the first direction, e.g. to obtain a comparison result; determining, based on the comparing (e.g., based on the at least one comparison result(s)), at least one shadow-related characteristic of the scene; and determining, based on the at least one shadow-related characteristic, whether the imaged scene includes an object which can constitute an obstacle to the platform. In some examples, the system is configured to image at least one selected depth-of-field of the scene by employing gated imaging. In some examples, the at least one shadow-related characteristic of the scene pertains to the at least one selected depth-of-field. In some examples, the system is configured to determine at least one shadow-related characteristics for a plurality of two different depth-of-fields of the scene. In some examples, determining the at least one shadow-related characteristic includes determining a direction and/or size of a shadow in the scene. In some examples, the system is configured to perform, based on the determined at least one shadow-related characteristic, one of the following: determining whether the scene includes an object that protrudes from a ground surface or background surface; determining a distance between one of the plurality of imagers and an object in the scene; determining a distance between the object in the scene and moving platform; increasing contrast of an object located in the scene; or any combination of the aforesaid. In some examples, the determining the at least one shadow-related characteristic comprises classifying an object in the scene as one of the following: “obstacle” or “non-obstacle”. In some examples, the plurality of imagers is activated simultaneously; activated alternatingly during non-overlapping time periods; or activated in at least partially overlapping time periods. In some examples, the system is configured to illuminate the ROI with at least one illuminator and at least one imager which are arranged such that a shadow cast by an object in the scene cannot be imaged by the at least one imager, to identify scene regions which are associated with false-positive shadows. In some examples, the system is configured to determine, based on the acquired images: at least two candidate ROIs of the imaged scene; a shadow-related characteristic of each of the at least two candidate ROIs; whether one or more of the at least two candidate ROIs comprises an object that can constitutes an obstacle to a moving platform based on the shadow-related characteristics of each of the two candidate ROIs; and providing an output descriptive of the characteristics of the at least two candidate ROIs.

### Further Examples

Example 1 pertains to a system for detecting an obstacle in a scene, the system comprising: a processor; and a memory configured to store data and software code executable by the processor to perform the following:
acquiring, by at least one imager, a plurality of images of a scene comprising at least one region of interest (ROI), wherein at least one of the plurality of images is acquired while the ROI is actively illuminated from at least two different directions by a plurality of illuminators;
determining, based on the plurality of images, a shadow-related characteristic of the at least one ROI; and
determining, based on the shadow-related characteristic, whether the imaged at least one ROI includes an object which can constitute an obstacle or not to a moving or stationary platform in the scene.

Example 2 includes the subject matter of Example 1 and, optionally, 1, wherein determining the shadow-related characteristic includes determining a direction and/or size of a shadow in the at least one ROI.

Example 3 includes the subject matter of Examples 1 or 2 and, optionally, wherein the system is further configured to perform, based on the determined shadow-related characteristic, one of the following:
determining whether the at least one ROI includes an object that protrudes from a ground or background surface or not;
determining a distance between the at least one imager and the at least one ROI;
determining a distance between the at least one ROI and the moving platform;
increasing contrast of an object located in the ROI, or any combination of the aforesaid.

Example 4 includes the subject matter of any one or more of the Examples 1 to 3 and, optionally, wherein determining the shadow-related characteristic comprises classifying the at least one ROI as one of the following: “obstacle” or “non-obstacle”.

Example 5 includes the subject matter of any one or more of the Examples 1 to 4 and, optionally, wherein the plurality of illuminators is activated simultaneously; activated alternatingly during non-overlapping time periods; or activated in at partially overlapping time periods.

Example 6 includes the subject matter of any one or more of the Examples 1 to 5 and, optionally, at least one illuminator; and at least one imager, wherein the at least one illuminator and imager are arranged such that no shadow is cast by an object in the ROI when being illuminated by the at least one illuminator for identifying scene regions which are associated with false-positive shadows.

Example 7 includes the subject matter of any one or more of the Examples 1 to 6 and, optionally, wherein the system is further configured to determine, based on the acquired images:
at least two candidate ROIs of the imaged scene;
a shadow-related characteristic of each of the at least two candidate ROIs; and
based on the shadow-related characteristics of each of the two candidate ROIs, if any of the at least two candidate ROIs comprises an object that can constitutes an obstacle to a moving platform; and
wherein the system is further configured to provide an output descriptive of the characteristics of the at least two candidate ROIs.

Example 8 includes the subject matter of any one or more of the Examples 1 to 7 and, optionally, wherein actively illuminating the scene comprises:
simultaneously emitting light from at least one first and the at least one second illuminator of the plurality of illuminators, wherein light emitted from the at least one first illuminator has different characteristics than light emitted from the at least one second illuminator; and
differentiating between the plurality of acquired images based on the characteristics of the light emitted by the at least one first and the at least second illuminator.

Example 9 includes the subject matter of Example 8 and, optionally, wherein light characteristics comprise one of the following: a wavelength; light polarization; a phase difference; data encoded in the light; amplitude; or any combination of the aforesaid.

Example 10 includes the subject matter of any one or more of the Examples 1 to 9 and, optionally, wherein the system is configured to acquire an image of a scene by gating a plurality of pixel elements of the at least one imager for selectively acquiring reflections from different depth-of-fields (DOES).

Example 11 includes the subject matter of Example 10 and, optionally, wherein the gating of the plurality of pixel elements is performed for selectively acquiring reflections produced with respect to the plurality of different illumination positions.

Example 12 includes the subject matter of Example 11 and, optionally, wherein acquiring reflections comprises wavelength filtering to selectively acquire reflections with respect to the plurality of different illumination positions.

Example 13 includes the subject matter of any one or more of the Examples 1 to 12 and, optionally, wherein the system is further configured to post-process reflection-based image data to produce a plurality of reflection-based image data sets descriptive of reflected light acquired by the imager responsive to illuminating the scene from the plurality of illumination positions.

Example 14 pertains to a method for detecting an obstacle in a scene, the method comprising:
acquiring, by at least one imager, a plurality of images of a scene comprising at least one region of interest (ROI), wherein at least one of the plurality of images is acquired while the ROI is actively illuminated from at least two different directions by a plurality of illuminators;
determining, based on the plurality of images, a shadow-related characteristic of the at least one ROI; and
determining, based on the shadow-related characteristic, whether the imaged at least one ROI includes an object which can constitute an obstacle or not to a moving platform in the scene.

Example 15 includes the subject matter of Example 14 and, optionally, wherein determining the shadow-related characteristic includes determining a direction and/or size of a shadow in the at least one ROI.

Example 16 includes the subject matter of Examples 14 or 15 and, optionally, further comprising performing, based on the determined shadow-related characteristic, one of the following:
determining whether the at least one ROI includes an object that protrudes from a ground or background surface or not;
determining a distance between the at least one imager and the at least one ROI;
determining a distance between the at least one ROI and the moving platform;
increasing contrast of an object located in the ROI; or any combination of the aforesaid.

Example 17 includes the subject matter of any one or more of the Examples 14 and 16 and, optionally, wherein determining the shadow-related characteristic comprises classifying the at least one ROI as one of the following: “obstacle” or “non-obstacle”.

Example 18 includes the subject matter of any one or more of the examples 14-17 and, optionally, wherein the plurality of illuminators is activated simultaneously; activated alternatingly during non-overlapping time periods; or activated in at partially overlapping time periods.

Example 19 includes the subject matter of any one or more of the Examples 14-18 and, optionally, further comprising illuminating the ROI with at least one illuminator and at least one imager which are arranged such that no shadow is cast by an object in the ROI when being illuminated by the at least one illuminator to identify scene regions which are associated with false-positive shadows.

Example 20 includes the subject matter of any one or more of the Examples 14 to 19 and, optionally, further comprising, based on the acquired images:
determining at least two candidate ROIs of the imaged scene;
determining a shadow-related characteristic of each of the at least two candidate ROIs; and
determining, based on the shadow-related characteristics of each of the two candidate ROIs, if any of the at least two candidate ROIs comprises an object that can constitutes an obstacle to a moving platform; and
providing an output descriptive of the characteristics of the at least two candidate ROIs.

Example 21 includes the subject matter of any one or more of the Examples 14-20 and, optionally, wherein actively illuminating the scene comprises:
simultaneously emitting light from at least one first and the at least one second illuminator of the plurality of illuminators, wherein light emitted from the at least one first illuminator has different characteristics than light emitted from the at least one second illuminator; and
differentiating between the plurality of acquired images based on the characteristics of the light emitted by the at least one first and the at least second illuminator.

Example 22 includes the subject matter of Example 21 and, optionally, wherein characteristics of light comprise one the following: a wavelength; light polarization; a phase difference; data encoded in the light; amplitude; or any combination of the aforesaid.

Example 23 includes the subject matter of any one or more of the examples 14 to 22 and, optionally, wherein acquiring an image of a scene comprises: gating a plurality of pixel elements of the at least one imager for selectively acquiring reflections from different depth-of-fields (DOES).

Example 24 includes the subject matter of example 23 and, optionally, wherein the gating of the plurality of pixel elements is performed for selectively acquiring reflections produced with respect to the plurality of different illumination positions.

Example 25 includes the subject matter of Example 24 and, optionally, wherein acquiring reflections comprises wavelength filtering to selectively acquire reflections with respect to the plurality of different illumination positions.

Example 26 includes the subject matter of any one or more of the examples 14-25 and, optionally, wherein acquiring reflections comprises post-processing of reflection-based image data to produce a plurality of reflection-based image data sets descriptive of reflected light acquired by the imager responsive to illuminating the scene from the plurality of illumination positions.

Example 27 pertains to a system for detecting an obstacle in a scene, the system comprising: a processor; and
a memory configured to store data and software code portions executable by the processor to perform the following:
acquiring, by a plurality of imagers, a plurality of images of a scene comprising at least one region of interest (ROI) from at least two different directions, wherein at least one of the plurality of images is acquired while the ROI is actively by at least one illuminator;
determining, based on the plurality of images, a shadow-related characteristic of the at least one ROI; and
determining, based on the shadow-related characteristic, whether the imaged at least one ROI includes an object which can constitute an obstacle or not to a moving platform in the scene.

Example 28 includes the subject matter of Example 27 and, optionally, wherein determining the shadow-related characteristic includes determining a direction and/or size of a shadow in the at least one ROI.

Example 29 includes the subject matter of examples 27 or 28 and, optionally, wherein the system is further configured to perform, based on the determined shadow-related characteristic, one of the following:
determining whether the at least one ROI includes an object that protrudes from a ground or background surface or not;
determining a distance between one of the plurality of imagers and the at least one ROI;
determining a distance between the at least one ROI and the moving platform;
increasing contrast of an object located in the ROI;
or any combination of the aforesaid.

Example 30 includes the subject matter of any one or more of the examples 27-29 and, optionally, wherein determining the shadow-related characteristic comprises classifying the at least one ROI as one of the following: “obstacle” or “non-obstacle”.

Example 31 includes the subject matter of any one or more of the Examples 27-30 and, optionally, wherein the plurality of imagers is activated simultaneously; activated alternatingly during non-overlapping time periods; or activated in at partially overlapping time periods.

Example 32 includes the subject matter of any one or more of the examples 27 to 31 and, optionally, configured to illuminate the ROI with at least one illuminator and at least one imager which are arranged such that no shadow is cast by an object in the ROI when being illuminated by the at least one illuminator to identify scene regions which are associated with false-positive shadows.

The system of any one of the examples 27 to 32 and, optionally, further configured to determine, based on the acquired images:
at least two candidate ROIs of the imaged scene;
a shadow-related characteristic of each of the at least two candidate ROIs;
if any of the at least two candidate ROIs comprises an object that can constitutes an obstacle to a moving platform based on the shadow-related characteristics of each of the two candidate ROIs; and
providing an output descriptive of the characteristics of the at least two candidate ROIs.

Any digital computer system, module and/or engine exemplified herein can be configured or otherwise programmed to implement a method disclosed herein, and to the extent that the system, module and/or engine is configured to implement such a method, it is within the scope and spirit of the disclosure. Once the system, module and/or engine are programmed to perform particular functions pursuant to computer readable and executable instructions from program software that implements a method disclosed herein, it in effect becomes a special purpose computer particular to embodiments of the method disclosed herein.

The methods and/or processes disclosed herein may be implemented as a computer program product that may be tangibly embodied in an information carrier including, for example, in a non-transitory tangible computer-readable and/or non-transitory tangible machine-readable storage device. The computer program product may directly loadable into an internal memory of a digital computer, comprising software code portions for performing the methods and/or processes as disclosed herein.

Additionally, or alternatively, the methods and/or processes disclosed herein may be implemented as a computer program that may be intangibly embodied by a computer readable signal medium. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a non-transitory computer or machine-readable storage device and that can communicate, propagate, or transport a program for use by or in connection with apparatuses, systems, platforms, methods, operations and/or processes discussed herein.

The terms “non-transitory computer-readable storage device” and “non-transitory machine-readable storage device” encompasses distribution media, intermediate storage media, execution memory of a computer, and any other medium or device capable of storing for later reading by a computer program implementing embodiments of a method disclosed herein. A computer program product can be deployed to be executed on one computer or on multiple computers at one site or distributed across multiple sites and interconnected by one or more communication networks.

These computer readable and executable instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable and executable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable and executable instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

In the discussion, unless otherwise stated, adjectives such as “substantially” and “about” that modify a condition or relationship characteristic of a feature or features of an embodiment of the invention, are to be understood to mean that the condition or characteristic is defined to within tolerances that are acceptable for operation of the embodiment for an application for which it is intended.

“Coupled with” can mean indirectly or directly “coupled with”.

It is important to note that the method may include is not limited to those diagrams or to the corresponding descriptions. For example, the method may include additional or even fewer processes or operations in comparison to what is described in the figures. In addition, embodiments of the method are not necessarily limited to the chronological order as illustrated and described herein.

Discussions herein utilizing terms such as, for example, “processing”, “computing”, “calculating”, “determining”, “establishing”, “analyzing”, “checking”, “estimating”, “deriving”, “selecting”, “inferring” or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes. The term determining may, where applicable, also refer to “heuristically determining”.

It should be noted that where an embodiment refers to a condition of “above a threshold”, this should not be construed as excluding an embodiment referring to a condition of “equal or above a threshold”. Analogously, where an embodiment refers to a condition “below a threshold”, this should not be construed as excluding an embodiment referring to a condition “equal or below a threshold”. It is clear that should a condition be interpreted as being fulfilled if the value of a given parameter is above a threshold, then the same condition is considered as not being fulfilled if the value of the given parameter is equal or below the given threshold. Conversely, should a condition be interpreted as being fulfilled if the value of a given parameter is equal or above a threshold, then the same condition is considered as not being fulfilled if the value of the given parameter is below (and only below) the given threshold.

Unless otherwise specified, the terms ‘about’, ‘substantially’ and/or ‘close’ with respect to a magnitude or a numerical value may imply to be within an inclusive range of −10% to +10% of the respective magnitude or value.

It should be understood that where the claims or specification refer to “a” or “an” element and/or feature, such reference is not to be construed as there being only one of that element. Hence, reference to “an element” or “at least one element” for instance may also encompass “one or more elements”.

Terms used in the singular shall also include the plural, except where expressly otherwise stated or where the context otherwise requires.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Unless otherwise stated, the use of the expression “and/or” between the last two members of a list of options for selection indicates that a selection of one or more of the listed options is appropriate and may be made. Further, the use of the expression “and/or” may be used interchangeably with the expressions “at least one of the following”, “any one of the following” or “one or more of the following”, followed by a listing of the various options.

It is appreciated that certain features of the invention, which are, for clarity, described in the context of separate embodiments or example, may also be provided in any suitable combination in a single embodiment. Conversely, various features of the invention, which are, for brevity, described in the context of a single embodiment, example and/or option, may also be provided separately or in any suitable sub-combination or as suitable in any other described embodiment, example or option of the invention. Certain features described in the context of various embodiments, examples and/or optional implementation are not to be considered essential features of those embodiments, unless the embodiment, example and/or optional implementation is inoperative without those elements.

It is noted that the term “exemplary” is used herein to refer to examples of embodiments and/or implementations, and is not meant to necessarily convey a more-desirable use-case.

It is noted that the terms “in some embodiments”, “according to some embodiments”, “for example”, “e.g.,”, “for instance” and “optionally” may herein be used interchangeably.

The number of elements shown in the Figures should by no means be construed as limiting and is for illustrative purposes only.

Throughout this application, various embodiments may be presented in and/or relate to a range format. It should be understood that the description in range format is merely for convenience and brevity and should not be construed as an inflexible limitation on the scope of the embodiments. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Where applicable, whenever a numerical range is indicated herein, it is meant to include any cited numeral (fractional or integral) within the indicated range.

The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

As used herein, if a machine (e.g., a processor) is described as “configured to” perform a task (e.g., configured to cause application of a predetermined field pattern), then, at least in some embodiments, the machine may include components, parts, or aspects (e.g., software) that enable the machine to perform a particular task. In some embodiments, the machine may perform this task during operation.

While the invention has been described with respect to a limited number of embodiments, these should not be construed as limitations on the scope of the invention, but rather as exemplifications of some of the embodiments.

1. A system employed by a platform for detecting an obstacle to the platform in a scene, the system comprising:
a plurality of illuminators arranged at different locations of the platform;
at least one imager;
a processor; and
a memory configured to store data and software code executable by the processor to perform the following:
illuminating the scene from at least two different directions by the plurality of illuminators;
acquiring, by the at least one imager, a plurality of images of the illuminated scene;
comparing at least one image of the scene illuminated from a first direction with at least one image of the scene illuminated from a second direction which is different from the first direction;
determining, based on the comparing, at least one shadow-related characteristic of the scene; and
determining, based on the at least one shadow-related characteristic, whether the scene includes an object which can constitute an obstacle to the platform.

2. The system of claim 1, configured to image at least one selected depth-of-field of the scene by employing gated imaging.

3. The system of claim 1, wherein the at least one shadow-related characteristic of the scene pertains to the at least one selected depth-of-field.

4. The system of claim 1, configured to determine at least one shadow-related characteristics for a plurality of two different depth-of-fields of the scene.

5. (canceled)

6. The system of claim 1, further configured to perform, based on the determined at least one shadow-related characteristic, one of the following:
determining whether the scene includes an object that protrudes from a ground surface, or a background surface;
determining a distance between the at least one imager and an object in the scene;
determining a distance between the object in the scene and the platform;
increasing contrast of an object located in the scene; or
any combination of the aforesaid.

7. The system of claim 1, wherein determining the at least one shadow-related characteristic comprises classifying an object in the scene as one of the following: “obstacle” or “non-obstacle”.

8. (canceled)

9. The system of claim 1, further comprising:
at least one illuminator; and
at least one imager,
wherein the at least one illuminator and imager are arranged such that a shadow cast by an object in the scene cannot be imaged by the at least one imager, for identifying scene regions which are associated with false-positive shadows.

10. (canceled)

11. The system of claim 1, wherein actively illuminating the scene comprises:
simultaneously emitting light from at least one first and the at least one second illuminator of the plurality of illuminators, wherein light emitted from the at least one first illuminator has different characteristics than light emitted from the at least one second illuminator; and
differentiating between the plurality of acquired images based on the characteristics of the light emitted by the at least one first and the at least second illuminator.

12. (canceled)

13. The system of claim 1, configured to
actively illuminate the scene with pulsed light generated by at least one of the plurality of illuminator;
receiving, responsive to illuminating the scene with the pulsed light, reflections on at least one light sensor that comprises a plurality of pixel elements; and
gating at least one of the plurality of pixel elements of the at least one imager for converting the reflections into pixel values for generating reflection-based image data that is descriptive of at least one depth-of-field (DOF) range.

14. (canceled)

15. (canceled)

16. (canceled)

17. A method for detecting an obstacle to a platform in a scene, the method comprising:
actively illuminating a scene from at least two different directions by a plurality of illuminators of the platform, wherein the plurality of illuminators are arranged at different locations of the platform;
acquiring, by at least one imager of the platform, a plurality of images of the illuminated scene;
comparing at least one image of the scene illuminated from a first direction with at least one image of the scene illuminated from a second direction which is different from the first direction;
determining, based on the comparing, at least one shadow-related characteristic of the scene; and
determining, based on the at least one shadow-related characteristic, whether the imaged scene includes an object which can constitute an obstacle to the platform.

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. A system employed by a platform for detecting an obstacle to the platform in a scene, the system comprising:
a processor; and
a memory configured to store data and software code portions executable by the processor to perform the following:
acquiring, by a plurality of imagers, a plurality of images of a scene comprising at least one region of interest (ROI) from at least two different directions, wherein at least one of the plurality of images is acquired while the ROI is actively illuminated by at least one illuminator;
comparing at least one first image of the actively illuminated scene acquired from a first direction with at least one second image of the actively illuminated scene acquired from at least one second direction which is different from the first direction;
determining, based on the comparing, a shadow-related characteristic of the at least one ROI; and
determining, based on the shadow-related characteristic, whether the imaged at least one ROI includes an object which can constitute an obstacle or not to a moving platform in the scene.

34. The system of claim 33, configured to image at least one selected depth-of-field of the scene by employing gated imaging.

35. The system of claim 33, wherein the at least one shadow-related characteristic of the scene pertains to the at least one selected depth-of-field.

36. The system of claim 33, configured to determine at least one shadow-related characteristics for a plurality of two different depth-of-fields of the scene.

37. The system of claim 33, wherein determining the at least one shadow-related characteristic includes determining a direction and/or size of a shadow in the scene.

38. The system of claim 33, further configured to perform, based on the determined at least one shadow-related characteristic, one of the following:
determining whether the scene includes an object that protrudes from a ground surface or background surface;
determining a distance between one of the plurality of imagers and an object in the scene;
determining a distance between the object in the scene and moving platform;
increasing contrast of an object located in the scene;
or any combination of the aforesaid.

39. The system of claim 33, wherein determining the at least one shadow-related characteristic comprises classifying an object in the scene as one of the following: “obstacle” or “non-obstacle”.

40. The system of claim 33, wherein the plurality of imagers are activated simultaneously; activated alternatingly during non-overlapping time periods; or activated in at least partially overlapping time periods.

41. The system of claim 33, further configured to illuminate the ROI with at least one illuminator and at least one imager which are arranged such that a shadow cast by an object in the scene cannot be imaged by the at least one imager, to identify scene regions which are associated with false-positive shadows.

42. The system of claim 33, further configured to determine, based on the acquired images:
at least two candidate ROIs of the imaged scene;
a shadow-related characteristic of each of the at least two candidate ROIs;
whether one or more of the at least two candidate ROIs comprises an object that can constitutes an obstacle to a moving platform based on the shadow-related characteristics of each of the two candidate ROIs; and
providing an output descriptive of the characteristics of the at least two candidate ROIs.
